(19) United States
(12) Patent Application Publication
(10) Pub. No.: US 2026/0242283 A1
(43) Pub. Date: Aug. 20, 2026

(54) Carbonate Aggregates and Methods of Making and Using the Same

(71) Applicant: Blue Planet Systems Corporation, Los Gatos, CA (US)

(72) Inventors: Brent R. Constantz, Portola Valley, CA (US); Catherine Levey, Palo Alto, CA (US)

(21) Appl. No.: 19/327,828

(22) Filed: Sep. 12, 2025

Related U.S. Application Data
(60) Provisional application No. 63/695,050, filed on Sep. 16, 2024.

(51) Int. Cl. C04B 20/10; C01F 11/18; C04B 111/00

(52) U.S. Cl. CPC C04B 20/107; C01F 11/182; C01P 2002/74; C01P 2004/02; C04B 2111/00019

(57) ABSTRACT

Methods of making carbonate aggregates are provided. Aspects of the methods include preparing a carbonate slurry from a precipitation reaction mixture having predetermined conditions selected to produce an aggregate having desirable durability or friability and subjecting the resultant carbonate slurry to rotational action (optionally with an aggregate substrate) to produce a carbonate aggregate. Also provided are aggregate compositions produced by the methods, as well as compositions that include the carbonate coated aggregates, e.g., concretes, and uses thereof.

### CROSS-REFERENCE TO RELATED APPLICATION

Pursuant to 35 U.S.C. § 119(e), this application claims priority to the filing date of U.S. Provisional Patent Application Ser. No. 63/695,050 filed Sep. 16, 2024, the disclosure of which application is herein incorporated by reference.

### INTRODUCTION

Concrete is the most widely used engineering material in the world, due to its ease of placement and high load bearing capacity. It is estimated that the present world consumption of concrete is over 11 billion metric tons per year. (Concrete, Microstructure, Properties and Materials (2006, McGraw-Hill)).

The main components of concrete are cement, such as Portland cement, with the addition of coarse and fine aggregates, air and water. Aggregates in conventional concretes include sand, natural gravel and crushed stone. Artificial aggregates may also be used, especially in lightweight concretes. Once the component materials are mixed together, the mixture sets or hardens due to the chemical process of hydration in which the water reacts with the cement which bonds the aggregates together to form a stone-like material. The proportions of the component materials affect the physical properties of the resultant concrete and, as such, the proportions of mixture components are selected to meet the requirements of a particular application.

Portland cement is made primarily from limestone, certain clay minerals, and gypsum, in a high temperature process that drives off carbon dioxide and chemically combines the primary ingredients into new compounds. The energy required to fire the mixture consumes about 4 GJ per ton of cement produced.

Because carbon dioxide is generated by both the cement production process itself, as well as by energy plants that generate power to run the production process, cement production is a leading source of current carbon dioxide atmospheric emissions. It is estimated that cement plants account for 5% of global emissions of carbon dioxide. As global warming and ocean acidification become an increasing problem and the desire to reduce carbon dioxide gas emissions (a principal cause of global warming) continues, the cement production industry will fall under increased scrutiny.

Fossil fuels that are employed in cement plants include coal, natural gas, oil, used tires, municipal waste, petroleum coke and biofuels. Fuels are also derived from tar sands, oil shale, coal liquids, and coal gasification and biofuels that are made via syngas. Cement plants are a major source of CO₂ emissions, from both the burning of fossil fuels and the CO₂ released from the calcination which changes the limestone, shale and other ingredients to Portland cement. Cement plants also produce waste heat. Additionally, cement plants produce other pollutants like NOx, SOx, VOCs, particulates and mercury. Cement plants also produce cement kiln dust (CKD), which must sometimes be land filled, often in hazardous materials landfill sites.

CO₂ emissions have been identified as a major contributor to the phenomenon of global warming and ocean acidification. CO₂ is a by-product of combustion and it creates operational, economic, and environmental problems. It is expected that elevated atmospheric concentrations of CO₂ and other greenhouse gases will facilitate greater storage of heat within the atmosphere leading to enhanced surface temperatures and rapid climate change. CO₂ has also been interacting with the oceans driving down the pH toward 8.0. CO₂ monitoring has shown atmospheric CO₂ has risen from approximately 280 parts per million (ppm) in the 1950s to approximately 400 ppm today. The impact of climate change will likely be economically expensive and environmentally hazardous. Reducing potential risks of climate change will require sequestration of CO₂

### SUMMARY

Methods of making carbonate aggregates are provided. Aspects of the methods include preparing a carbonate slurry from a precipitation reaction mixture having predetermined conditions selected to produce an aggregate having desirable durability or friability and subjecting the resultant carbonate slurry to rotational action (optionally with an aggregate substrate) to produce a carbonate aggregate. Also provided are aggregate compositions produced by the methods, as well as compositions that include the carbonate coated aggregates, e.g., concretes, and uses thereof.

### BRIEF DESCRIPTION OF THE FIGURES

FIG. 1 provides an image of synthetic limestone stones made from the precipitated calcium carbonate.

FIG. 2 illustrates mass percentage which survived a durability (resistance to abrasion and impact) test. Calcium carbonate precipitated from a reaction which proceeded to an end pH below 8.00 produced bulk stones which survived the durability test (durable), while calcium carbonate precipitated from a reaction which was stopped at an end pH at or above 8.00 produced product which was degraded by the test (fragile).

FIG. 3A, FIG. 3B, FIG. 3C, and FIG. 3D show the microstructure of fracture surfaces of finished synthetic stones at a gradient of end pHs.

FIG. 4 shows the polymorphic composition throughout the course of the reaction. (A) Raw XRD data and (B) quantitative phase analysis results.

FIG. 5 provides an example of raw calorimetry data from DSC of the lyophilized end pH 8.75 sample.

FIG. 6 provides crystallization temperatures, as determined by DSC, of ACCs aliquoted throughout the pH gradient.

FIG. 7 provides enthalpy of ACC crystallization, as determined by DSC, of ACCs aliquoted throughout the pH gradient. All values are exothermic.

### DETAILED DESCRIPTION

Methods of making carbonate aggregates are provided. Aspects of the methods include preparing a carbonate slurry from a precipitation reaction mixture having predetermined conditions selected to produce an aggregate having desirable durability or friability and subjecting the resultant carbonate slurry to rotational action (optionally with an aggregate substrate) to produce a carbonate aggregate. Also provided are aggregate compositions produced by the methods, as well as compositions that include the carbonate coated aggregates, e.g., concretes, and uses thereof.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Methods of Making Carbonate Aggregates

As summarized above, aspects of the invention include methods of producing carbonate aggregates, such as carbonate coated aggregates. The term “aggregate” is used in its conventional sense to refer to a granular material, i.e., a material made up of grains or particles. As the aggregate is a carbonate aggregate, the particles of the granular material include one or more carbonate compounds, where the carbonate compound(s) component may be combined with other substances (e.g., substrates) or make up the entire particles, as desired. The carbonate aggregates produced by the methods of invention are described in greater detail below.

Aspects of the methods include producing the carbonate aggregates using predetermined conditions that are known to produce aggregates of desired physical properties, such as durability or friability. As such, in producing aggregates according to embodiments of the invention, production conditions are selected that are known to produce aggregates of desired properties, such as durability or friability. In some instances, aggregate production conditions are employed that are known to produce durable aggregates. In other embodiments, aggregate production conditions are employed that are known to produce friable aggregates. Accordingly, aspects of the invention include employing aggregate synthesis conditions that are known to produce aggregates of desired durability or friability. As used herein, aggregates are durable if they are able to resist degradation by abrasion and impact. Durable aggregates according to embodiments of the invention are aggregates that pass ASTM (American Society for Testing and Materials) test C131-06, e.g., aggregates in which 60% of their mass survive the test. As used herein, aggregates are friable if they are easily crumbled or reduced to powder. In some instances, aggregates are considered friable if they do not pass ASTM test C131-06.

As summarized above, aspects of the invention include preparing a carbonate slurry from a precipitation reaction mixture having predetermined conditions selected to produce an aggregate having desirable durability or friability and subjecting the resultant carbonate slurry to rotational action (optionally with an aggregate substrate) to produce a carbonate aggregate. Each of these steps is now described further in greater detail.

### Carbonate Slurry Production

The carbonate slurry produced in methods of the invention is a slurry that includes metal carbonate particles, such alkali earth metal carbonate particles, e.g., calcium carbonate particles, magnesium carbonate particles, etc., such as described in greater detail below. While percent solids of the carbonate slurries may vary, in some instances the carbonate slurry includes 30 to 80% solids, such as 40 to 60% solids. While the viscosity of the carbonate slurries may vary, in some instances the carbonate slurries have a viscosity ranging from 2 to 300,000, such as 9 to 900 and including 300 to 30,000 centipoise (cP or cps). While the size of the carbonate particles present in the slurry may vary, in some instances the particles range in size from 0.1 um to 50 um, such as 0.5 to 5 and including 5 to 50 um.

Carbonate slurries, such as described above, may be produced using any convenient protocol. In some instances, the carbonate slurries are produced using a CO₂ sequestering process. By CO₂ sequestering process is meant a process that converts an amount of gaseous CO₂ into a solid carbonate, there sequestering CO₂ as a solid mineral. A variety of different CO₂ sequestering processes may be employed to produce a carbonate slurry.

In some instances, an ammonia mediated CO₂ sequestering process is employed to produce the carbonate slurry. Embodiments of such methods include multistep or single step protocols, as desired. For example, in some embodiments, combination of a CO₂ capture liquid and gaseous source of CO₂ results in production of an aqueous carbonate, which aqueous carbonate is then subsequently contacted with a divalent cation source, e.g., a Ca²⁺ and/or Mg²⁺ source, to produce the carbonate slurry. In yet other embodiments, a one-step CO₂ gas absorption carbonate precipitation protocol is employed.

The CO₂ containing gas may be pure CO₂ or be combined with one or more other gasses and/or particulate components, depending upon the source, e.g., it may be a multi-component gas (i.e., a multi-component gaseous stream). In certain embodiments, the CO₂ containing gas is obtained from an industrial plant, e.g., where the CO₂ containing gas is a waste feed from an industrial plant. Industrial plants from which the CO₂ containing gas may be obtained, e.g., as a waste feed from the industrial plant, may vary. Industrial plants of interest include, but are not limited to, power plants and industrial product manufacturing plants, such as, but not limited to, chemical and mechanical processing plants, refineries, cement plants, steel plants, etc., as well as other industrial plants that produce CO₂ as a byproduct of fuel combustion or other processing step (such as calcination by a cement plant). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, as well as man-made fuel products of naturally occurring organic fuel deposits, such as but not limited to tar sands, heavy oil, oil shale, etc. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Each of these types of industrial plants may burn a single fuel, or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant.

These industrial plants may each burn a single fuel or may burn two or more fuels sequentially or simultaneously. Other industrial plants such as smelters and refineries are also useful sources of waste streams that include carbon dioxide.

Industrial waste gas streams may contain carbon dioxide as the primary non-air derived component, or may, especially in the case of coal-fired power plants, contain additional components (which may be collectively referred to as non-CO₂ pollutants) such as nitrogen oxides (NOx), sulfur oxides (SOx), and one or more additional gases. Additional gases and other components may include CO, mercury and other heavy metals, and dust particles (e.g., from calcining and combustion processes). Additional non-CO₂ pollutant components in the gas stream may also include halides such as hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and PAH compounds. Suitable gaseous waste streams that may be treated have, in some embodiments, CO₂ present in amounts of 200 ppm to 1,000,000 ppm; or 200 ppm to 500,000 ppm; or 200 ppm to 100,000 ppm; or 200 ppm to 10,000; or 200 ppm to 5,000 ppm; or 200 ppm to 2000 ppm; or 200 ppm to 1000 ppm; or 200 to 500 ppm; or 500 ppm to 1,000,000 ppm; or 500 ppm to 500,000 ppm; or 500 ppm to 100,000 ppm; or 500 ppm to 10,000; or 500 ppm to 5,000 ppm; or 500 ppm to 2000 ppm; or 500 ppm to 1000 ppm; or 1000 ppm to 1,000,000 ppm; or 1000 ppm to 500,000 ppm; or 1000 ppm to 100,000 ppm; or 1000 ppm to 10,000; or 1000 ppm to 5,000 ppm; or 1000 ppm to 2000 ppm; or 2000 ppm to 1,000,000 ppm; or 2000 ppm to 500,000 ppm; or 2000 ppm to 100,000 ppm; or 2000 ppm to 10,000; or 2000 ppm to 5,000 ppm; or 2000 ppm to 3000 ppm; or 5000 ppm to 1,000,000 ppm; or 5000 ppm to 500,000 ppm; or 5000 ppm to 100,000 ppm; or 5000 ppm to 10,000; or 10,000 ppm to 1,000,000 ppm; or 10.00 ppm to 500,000 ppm; or 10,000 ppm to 100,000 ppm; or 50,000 ppm to 1,000,000 ppm; or 50,000 ppm to 500,000 ppm; or 50,000 ppm to 100,000 ppm; or 100,000 ppm to 1,000,000 ppm; or 100,000 ppm to 500,000 ppm; or 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm.

The waste streams, particularly various waste streams of combustion gas, may include one or more additional non-CO₂ components, for example only, water, NOx (mononitrogen oxides: NO and NO₂), SOx (monosulfur oxides: SO, SO₂ and SO₃), VOC (volatile organic compounds), heavy metals such as, but not limited to, mercury, and particulate matter (particles of solid or liquid suspended in a gas). Flue gas temperature may also vary. In some embodiments, the temperature of the flue gas comprising CO₂ is from 0° C. to 2000° C., or 0° C. to 1000° C., or 0° C. to 500° C., or 0° C. to 100° C., or 0° C. to 50° C., or 10° C. to 2000° C., or 10° C. to 1000° C., or 10° C. to 500° C., or 10° C. to 100° C., or 10° C. to 50° C., or 50° C. to 2000° C., or 50° C. to 1000° C., or 50° C. to 500° C., or 50° C. to 100° C., or 100° C. to 2000° C., or 100° C. to 1000° C., or 100° C. to 500° C., or 500° C. to 2000° C., or 500° C. to 1000° C., or 500° C. to 800° C., or such as from 60° C. to 700° C., and including 100° C. to 400° C.

Another gaseous source of CO₂ is a direct air capture (DAC) generated gaseous source of CO₂. The DAC generated gaseous source of CO₂ is a product gas produced by a direct air capture (DAC) system. DAC systems are a class of technologies capable of separating carbon dioxide CO₂ directly from ambient air. A DAC system is any system that captures CO₂ directly from air and generates a product gas that includes CO₂ at a higher concentration than that of the air that is input into the DAC system. While the concentration of CO₂ in the DAC generated gaseous source of CO₂ may vary, in some instances the concentration 1,000 ppm or greater, such as 10,000 ppm or greater, including 100,000 ppm or greater, where the product gas may not be pure CO₂, such that in some instances the product gas is 3% or more non-CO₂ constituents, such as 5% or more non-CO₂ constituents, including 10% or more non-CO₂ constituents. Non-CO₂ constituents that may be present in the product stream may be constituents that originate in the input air and/or from the DAC system. In some instances, the concentration of CO₂ in the DAC product gas ranges from 1,000 to 999,000 ppm, such as 1,000 to 10,000 ppm, or 10,000 to 100,000 ppm or 100,000 to 999,000 ppm. DAC generated gaseous streams have, in some embodiments, CO₂ present in amounts of 200 ppm to 1,000,000 ppm; or 200 ppm to 500,000 ppm; or 200 ppm to 100,000 ppm; or 200 ppm to 10,000; or 200 ppm to 5,000 ppm; or 200 ppm to 2000 ppm; or 200 ppm to 1000 ppm; or 200 to 500 ppm; or 500 ppm to 1,000,000 ppm; or 500 ppm to 500,000 ppm; or 500 ppm to 100,000 ppm; or 500 ppm to 10,000; or 500 ppm to 5,000 ppm; or 500 ppm to 2000 ppm; or 500 ppm to 1000 ppm; or 1000 ppm to 1,000,000 ppm; or 1000 ppm to 500,000 ppm; or 1000 ppm to 100,000 ppm; or 1000 ppm to 10,000; or 1000 ppm to 5,000 ppm; or 1000 ppm to 2000 ppm; or 2000 ppm to 1,000,000 ppm; or 2000 ppm to 500,000 ppm; or 2000 ppm to 100,000 ppm; or 2000 ppm to 10,000; or 2000 ppm to 5,000 ppm; or 2000 ppm to 3000 ppm; or 5000 ppm to 1,000,000 ppm; or 5000 ppm to 500,000 ppm; or 5000 ppm to 100,000 ppm; or 5000 ppm to 10,000; or 10,000 ppm to 1,000,000 ppm; or 10.00 ppm to 500,000 ppm; or 10,000 ppm to 100,000 ppm; or 50,000 ppm to 1,000,000 ppm; or 50,000 ppm to 500,000 ppm; or 50,000 ppm to 100,000 ppm; or 100,000 ppm to 1,000,000 ppm; or 100,000 ppm to 500,000 ppm; or 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. The DAC product gas that is contacted with the aqueous capture liquid may be produced by any convenient DAC system. DAC systems are systems that extract CO₂ from the air using media that binds to CO₂ but not to other atmospheric chemicals (such as nitrogen and oxygen). As air passes over the CO₂ binding medium, CO₂ “sticks” to the binding medium. In response to a stimulus, e.g., heat, humidity, etc., the bound CO₂ may then be released from the binding medium resulting the production of a gaseous CO₂ containing product. DAC systems of interest include, but are not limited to: hydroxide based systems; CO₂ sorbent/temperature swing based systems, and CO₂ sorbent/temperature swing based systems. In some instances, the DAC system is a hydroxide based system, in which CO₂ is separated from air by contacting the air with is an aqueous hydroxide liquid. Examples of hydroxide based DAC systems include, but are not limited to, those described in PCT published application Nos. WO/2009/155539; WO/2010/022339; WO/2013/036859; and WO/2013/120024; the disclosures of which are herein incorporated by reference. In some instances, the DAC system is a CO₂ sorbent based system, in which CO₂ is separated from air by contacting the air with sorbent, such as an amine sorbent, followed by release of the sorbent captured CO₂ by subjecting the sorbent to one or more stimuli, e.g., change in temperature, change in humidity, etc. Examples of such DAC systems include, but are not limited to, those described in PCT published application Nos. WO/2005/108297; WO/2006/009600; WO/2006/023743; WO/2006/036396; WO/2006/084008; WO/2007/016271; WO/2007/114991; WO/2008/042919; WO/2008/061210; WO/2008/131132; WO/2008/144708; WO/2009/061836; WO/2009/067625; WO/2009/105566; WO/2009/149292; WO/2010/019600; WO/2010/022399; WO/2010/107942; WO/2011/011740; WO/2011/137398; WO/2012/106703; WO/2013/028688; WO/2013/075981; WO/2013/166432; WO/2014/170184; WO/2015/103401; WO/2015/185434; WO/2016/005226; WO/2016/037668; WO/2016/162022; WO/2016/164563; WO/2016/161998; WO/2017/184652; and WO/2017/009241; the disclosures of which are herein incorporated by reference. Further details regarding DAC generated gaseous sources of CO₂ and their use in producing carbonate slurries may be found in PCT application serial no. PCT/US2018/020527 published as WO 2018/160888, the disclosure of which is herein incorporated by reference.

Another source of gaseous CO₂ that may be employed in embodiments of the invention is ambient air. Such embodiments include directly contacting an aqueous capture liquid with the ambient air to produce a CO₂ sequestering carbonate and CO₂-depleted air to sequester the CO₂ from the ambient air. Ambient air contacted with the aqueous capture liquid may, in some embodiments, have an amount of CO₂ ranging from 300 ppm to 500 ppm. In addition, CO₂-depleted air may have, in some embodiments, an amount of CO₂ ranging from 100 ppm to 300 ppm. In some cases, directly contacting the aqueous capture liquid with the ambient air comprises drawing in the ambient air from a surrounding environment using a gas conveyor, and contacting the ambient air with the capture liquid. Gas conveyors may include, for example, an air pump or a turbine. In select embodiments, the gas conveyor is powered by a source of green energy, such as wind energy, hydroelectric energy, solar energy, geothermal energy or nuclear energy. The manner in which the aqueous capture liquid is contacted with the ambient air can include, for example, counter-current, co-current, or cross-current manners. Further details regarding such embodiments may be found in U.S. Provisional Patent Application Ser. No. 63/664,950; the disclosure of which is herein incorporated by reference.

As summarized above, an aqueous capture liquid is contacted with the gaseous source of CO₂ under conditions sufficient to produce an aqueous carbonate. The aqueous capture liquid may vary. Examples of aqueous capture liquids include, but are not limited to fresh water to bicarbonate buffered aqueous media. Bicarbonate buffered aqueous media employed in embodiments of the invention include liquid media in which a bicarbonate buffer is present. The bicarbonate buffered aqueous medium may be a naturally occurring or man-made medium, as desired. Naturally occurring bicarbonate buffered aqueous media include, but are not limited to, waters obtained from seas, oceans, lakes, swamps, estuaries, lagoons, brines, alkaline lakes, inland seas, etc. Man-made sources of bicarbonate buffered aqueous media may also vary, and may include brines produced by water desalination plants, and the like. Further details regarding such capture liquids are provided in PCT published application Nos. WO2014/039578; WO 2015/134408; and WO 2016/057709; the disclosures of which applications are herein incorporated by reference.

In some embodiments, an aqueous capture ammonia is contacted with the gaseous source of CO₂ under conditions sufficient to produce an aqueous ammonium carbonate. The concentration of ammonia in the aqueous capture ammonia may vary, where in some instances the aqueous capture ammonia includes ammonia (NH₃) at a concentration ranging from 10 ppm to 350,000 ppm NH₃, such as 10 to 10,000 ppm, or 10 to 1,000 ppm, or 10 to 5,000 ppm, or 10 to 8,000 ppm, or 10 to 10,000 ppm, or 100 to 100,000 ppm, or 100 to 10,000 ppm, or 100 to 50,000 ppm, or 100 to 80,000 ppm, or 100 to 100,000 ppm, or 1,000 to 350,000 ppm, or 1,000 to 50,000 ppm, or 1,000 to 80,000 ppm, or 1,000 to 100,000 ppm, or 1,000 to 200,000 ppm, or 1,000 to 350,000 ppm, or such as from 6,000 to 85,000 ppm, and including 8,000 to 50,000 ppm. The aqueous capture ammonia may include any convenient water. Waters of interest from which the aqueous capture ammonia may be produced include, but are not limited to, freshwaters, seawaters, brine waters, reclaimed or recycled waters, produced waters and waste waters. The pH of the aqueous capture ammonia may vary, ranging in some instances from 9.0 to 13.5, such as 9.0 to 13.0, including 10.5 to 12.5. Further details regarding aqueous capture ammonias of interest are provided in PCT published application No. WO 2017/165849; the disclosure of which is herein incorporated by reference.

As summarized above, an aqueous capture liquid is contacted with the gaseous source of CO₂ under conditions sufficient to produce an aqueous carbonate. The aqueous capture liquid may vary. Examples of aqueous capture liquids include, but are not limited to fresh water to bicarbonate buffered aqueous media. Bicarbonate buffered aqueous media employed in embodiments of the invention include liquid media in which a bicarbonate buffer is present. The bicarbonate buffered aqueous medium may be a naturally occurring or man-made medium, as desired. Naturally occurring bicarbonate buffered aqueous media include, but are not limited to, waters obtained from seas, oceans, lakes, swamps, estuaries, lagoons, brines, alkaline lakes, inland seas, etc. Man-made sources of bicarbonate buffered aqueous media may also vary, and may include brines produced by water desalination plants, and the like. Further details regarding such capture liquids are provided in PCT published application Nos. WO2014/039578; WO 2015/134408; and WO 2016/057709; the disclosures of which applications are herein incorporated by reference.

In some embodiments, an aqueous capture ammonia is contacted with the gaseous source of CO₂ under conditions sufficient to produce an aqueous ammonium carbonate. The concentration of ammonia in the aqueous capture ammonia may vary, where in some instances the aqueous capture ammonia includes ammonia (NH₃) at a concentration ranging from 10 ppm to 350,000 ppm NH₃, such as 10 to 10,000 ppm, or 10 to 1,000 ppm, or 10 to 5,000 ppm, or 10 to 8,000 ppm, or 10 to 10,000 ppm, or 100 to 100,000 ppm, or 100 to 10,000 ppm, or 100 to 50,000 ppm, or 100 to 80,000 ppm, or 100 to 100,000 ppm, or 1,000 to 350,000 ppm, or 1,000 to 50,000 ppm, or 1,000 to 80,000 ppm, or 1,000 to 100,000 ppm, or 1,000 to 200,000 ppm, or 1,000 to 350,000 ppm, or such as from 6,000 to 85,000 ppm, and including 8,000 to 50,000 ppm. The aqueous capture ammonia may include any convenient water. Waters of interest from which the aqueous capture ammonia may be produced include, but are not limited to, freshwaters, seawaters, brine waters, reclaimed or recycled waters, produced waters and waste waters. The pH of the aqueous capture ammonia may vary, ranging in some instances from 9.0 to 13.5, such as 9.0 to 13.0, including 10.5 to 12.5. Further details regarding aqueous capture ammonias of interest are provided in PCT published application No. WO 2017/165849; the disclosure of which is herein incorporated by reference.

The CO₂ containing gas, e.g., as described above, may be contacted with the aqueous capture liquid, e.g., aqueous capture ammonia, using any convenient protocol. For example, contact protocols of interest include, but are not limited to: direct contacting protocols, e.g., bubbling the gas through a volume of the aqueous medium, concurrent contacting protocols, i.e., contact between unidirectionally flowing gaseous and liquid phase streams, countercurrent protocols, i.e., contact between oppositely flowing gaseous and liquid phase streams, and the like. Contact may be accomplished through use of infusers, bubblers, fluidic Venturi reactors, spargers, gas filters, sprays, trays, scrubbers, absorbers or packed column reactors, and the like, as may be convenient. In some instances, the contacting protocol may use a conventional absorber or an absorber froth column, such as those described in U.S. Pat. Nos. 7,854,791; 6,872,240; and 6,616,733; and in United States Patent Application Publication US-2012-0237420-A1; the disclosures of which are herein incorporated by reference. The process may be a batch or continuous process. In some instances, a regenerative froth contactor (RFC) may be employed to contact the CO₂ containing gas with the aqueous capture liquid, e.g., aqueous capture ammonia. In some such instances, the RFC may use a catalyst (such as described elsewhere), e.g., a catalyst that is immobilized on/to the internals of the RFC. Further details regarding a suitable RFC are found in U.S. Pat. No. 9,545,598, the disclosure of which is herein incorporated by reference.

In some instances, the gaseous source of CO₂ is contacted with the liquid using a microporous membrane contactor. Microporous membrane contactors of interest include a microporous membrane present in a suitable housing, where the housing includes a gas inlet and a liquid inlet, as well a gas outlet and a liquid outlet. The contactor is configured so that the gas and liquid contact opposite sides of the membrane in a manner such that molecule may dissolve into the liquid from the gas via the pores of the microporous membrane. The membrane may be configured in any convenient format, where in some instances the membrane is configured in a hollow fiber format. Hollow fiber membrane reactor formats which may be employed include, but are not limited to, those described in U.S. Pat. Nos. 7,264,725; 6,872,240 and 5,695,545; the disclosures of which are herein incorporated by reference. In some instances, the microporous hollow fiber membrane contactor that is employed is a hollow fiber membrane contactor, which membrane contactors include polypropylene membrane contactors and polyolefin membrane contactors.

Contact between the capture liquid and the CO₂-containing gas occurs under conditions such that a substantial portion of the CO₂ present in the CO₂-containing gas goes into solution, e.g., to produce bicarbonate ions. By substantial portion is meant 10% or more, such as 50% or more, including 80% or more.

The temperature of the capture liquid that is contacted with the CO₂-containing gas may vary. In some instances, the temperature ranges from −1.4 to 100° C., such as 20 to 80° C. and including 40 to 70° C. In some instances, the temperature may range from −1.4 to 50° C. or higher, such as from −1.1 to 45° C. or higher. In some instances, cooler temperatures are employed, where such temperatures may range from −1.4 to 4° C., such as −1.1 to 0° C. In some instances, warmer temperatures are employed. For example, the temperature of the capture liquid in some instances may be 25° C. or higher, such as 30° C. or higher, and may in some embodiments range from 25 to 50° C., such as 30 to 40° C.

The CO₂-containing gas and the capture liquid are contacted at a pressure suitable for production of a desired CO₂ charged liquid. In some instances, the pressure of the contact conditions is selected to provide for optimal CO₂ absorption, where such pressures may range from 1 ATM to 100 ATM, such as 1 to 50 ATM, e.g., 20-30 ATM or 1 ATM to 10 ATM. Where contact occurs at a location that is naturally at 1 ATM, the pressure may be increased to the desired pressure using any convenient protocol. In some instances, contact occurs where the optimal pressure is present, e.g., at a location under the surface of a body of water, such as an ocean or sea.

In those embodiments where the gaseous source of CO₂ is contacted with an aqueous capture ammonia, contact is carried out in manner sufficient to produce an aqueous ammonium carbonate. The aqueous ammonium carbonate may vary, where in some instances the aqueous ammonium carbonate comprises at least one of ammonium carbonate and ammonium bicarbonate and in some instances comprises both ammonium carbonate and ammonium bicarbonate. The aqueous ammonium bicarbonate may be viewed as a DIC containing liquid. As such, in charging the aqueous capture ammonia with CO₂, a CO₂ containing gas may be contacted with CO₂ capture liquid under conditions sufficient to produce dissolved inorganic carbon (DIC) in the CO₂ capture liquid, i.e., to produce a DIC containing liquid. The DIC is the sum of the concentrations of inorganic carbon species in a solution, represented by the equation: DIC=[CO₂*]+[HCO₃⁻]+[CO₃²⁻], where [CO₂*] is the sum of carbon dioxide ([CO₂]) and carbonic acid ([H₂CO₃]) concentrations, [HCO₃⁻] is the bicarbonate concentration (which includes ammonium bicarbonate) and [CO₃²⁻] is the carbonate concentration (which includes ammonium carbonate) in the solution. The DIC of the aqueous media may vary, and in some instances may be 3 ppm to 168,000 ppm carbon (C), such as 3 to 1,000 ppm, or 3 to 100 ppm, or 3 to 500 ppm, or 3 to 800 ppm, or 3 to 1,000 ppm, or 100 to 10,000 ppm, or 100 to 1,000 ppm, or 100 to 5,000 ppm, or 100 to 8,000 ppm, or 100 to 10,000 ppm, or 1,000 to 50,000 ppm, or 1,000 to 8,000 ppm, or 1,000 to 15,000 ppm, or 1,000 to 30,000 ppm, or 5,000 to 168,000 ppm, or 5,000 to 25,000 ppm, or such as from 6,000 to 65,000 ppm, and including 8,000 to 95,000 ppm carbon (C). The amount of CO₂ dissolved in the liquid may vary, and in some instances ranges from 0.05 to 40 mM, such as 1 to 35 mM, including 25 to 30 mM. The pH of the resultant DIC containing liquid may vary, ranging in some instances from 4 to 12, such as 6 to 11 and including 7 to 11, e.g., 8 to 9.5.

Where desired, the CO₂ containing gas is contacted with the capture liquid in the presence of a catalyst (i.e., an absorption catalyst, either hetero- or homogeneous in nature) that mediates the conversion of CO₂ to bicarbonate. Of interest as absorption catalysts are catalysts that, at pH levels ranging from 8 to 10, increase the rate of production of bicarbonate ions from dissolved CO₂. The magnitude of the rate increase (e.g., as compared to control in which the catalyst is not present) may vary, and in some instances is 2-fold or greater, such as 5-fold or greater, e.g., 10-fold or greater, as compared to a suitable control. Further details regarding examples of suitable catalysts for such embodiments are found in U.S. Pat. No. 9,707,513, the disclosure of which is herein incorporated by reference.

In some embodiments, the resultant aqueous ammonium carbonate is a two-phase liquid which includes droplets of a liquid condensed phase (LCP) in a bulk liquid, e.g., bulk solution. By “liquid condensed phase” or “LCP” is meant a phase of a liquid solution which includes bicarbonate ions wherein the concentration of bicarbonate ions is higher in the LCP phase than in the surrounding, bulk liquid. LCP droplets are characterized by the presence of a meta-stable bicarbonate-rich liquid precursor phase in which bicarbonate ions associate into condensed concentrations exceeding that of the bulk solution and are present in a non-crystalline solution state. The LCP contains all of the components found in the bulk solution that is outside of the interface. However, the concentration of the bicarbonate ions is higher than in the bulk solution. In those situations where LCP droplets are present, the LCP and bulk solution may each contain ion-pairs and pre-nucleation clusters (PNCs). When present, the ions remain in their respective phases for long periods of time, as compared to ion-pairs and PNCs in solution. Further details regarding LCP containing liquids are provided in U.S. patent application Ser. No. 14/636,043, the disclosure of which is herein incorporated by reference.

As summarized above, both multistep and single step protocols may be employed to produce the CO₂ sequestering carbonate slurry from the CO₂ containing gas the aqueous capture ammonia. For example, in some embodiments the product aqueous ammonium carbonate is forwarded to a CO₂ sequestering carbonate slurry production module, where divalent cations, e.g., Ca²⁺ and/or Mg²⁺, are combined with the aqueous ammonium carbonate to produce the CO₂ sequestering carbonate slurry. In yet other instances, aqueous capture ammonia includes a source of divalent cations, e.g., Ca²⁺ and/or Mg²⁺, such that aqueous ammonium carbonate combines with the divalent cations as it is produced to result in production of a CO₂ sequestering carbonate slurry.

Accordingly, in some embodiments, following production of an aqueous carbonate, such as an aqueous ammonium carbonate, e.g., as described above, the aqueous carbonate is subsequently combined with a cation source under conditions sufficient to produce a solid CO₂ sequestering carbonate. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium (Ca²⁺) and magnesium (Mg²⁺) cations, may be employed. When cations are added to the aqueous carbonate, precipitation of carbonate solids, such as amorphous calcium carbonate (CaCO₃) when the divalent cations include Ca²⁺, may be produced with a stoichiometric ratio of one carbonate-species ion per cation.

Any convenient cation source may be employed in such instances. Cation sources of interest include, but are not limited to, the brine from water processing facilities such as sea water desalination plants, brackish water desalination plants, groundwater recovery facilities, wastewater facilities, blowdown water from facilities with cooling towers, and the like, which produce a concentrated stream of solution high in cation contents. Also of interest as cation sources are naturally occurring sources, such as but not limited to native seawater and geological brines, which may have varying cation concentrations and may also provide a ready source of cations to trigger the production of carbonate solids from the aqueous ammonium carbonate. In some instances, the cation source may be a waste product of another step of the process, e.g., a calcium salt (such as CaCl₂) produced during regeneration of ammonia from the aqueous ammonium salt.

Following production of an aqueous carbonate, such as an aqueous ammonium carbonate, e.g., as described above, the aqueous carbonate is combined with a cation source under conditions sufficient to produce a solid CO₂ sequestering carbonate. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium and magnesium cations, may be employed. Transition metals may also be employed, e.g., Fe, Mn, Cu, etc. When cations are added to the aqueous carbonate, precipitation of carbonate solids, such as amorphous calcium carbonate when the divalent cations include Ca²⁺, may be produced with a stoichiometric ratio of one carbonate-species ion per cation.

Any convenient cation source may be employed in such instances. Cation sources of interest include, but are not limited to, the brine from water processing facilities such as sea water desalination plants, brackish water desalination plants, groundwater recovery facilities, wastewater facilities, and the like, which produce a concentrated stream of solution high in cation contents. Also of interest as cation sources are naturally occurring sources, such as but not limited to native seawater and geological brines, which may have varying cation concentrations and may also provide a ready source of cations to trigger the production of carbonate solids from the aqueous ammonium carbonate. In some instances, the cation source may be a waste product of another step of the process, e.g., a calcium salt (such as CaCl₂) produced during regeneration of ammonia from the aqueous ammonium salt.

As summarized above, production of CO₂ sequestering carbonate from the aqueous ammonia capture liquid and the gaseous source of CO₂ yields an aqueous ammonium salt. The produced aqueous ammonium salt may vary with respect to the nature of the anion of the ammonium salt, where specific ammonium salts that may be present in the aqueous ammonium salt include, but are not limited to, ammonium chloride, ammonium acetate, ammonium sulfate, ammonium nitrate, etc.

As reviewed above, aspects of the invention further include regenerating an aqueous capture ammonia, e.g., as described above, from the aqueous ammonium salt. By regenerating an aqueous capture ammonium is meant processing the aqueous ammonium salt in a manner sufficient to generate an amount of ammonium from the aqueous ammonium salt. The percentage of input ammonium salt that is converted to ammonia during this regeneration step may vary, ranging in some instances from 5 to 80%, such as 15 to 55%, and in some instances 20 to 80%, e.g., 35 to 55%.

Further details regarding such embodiments may be found in U.S. Pat. No. 10,322,371, the disclosure of which is herein incorporated by reference.

In yet other embodiments, the aqueous capture ammonia includes cations, e.g., as described above. The cations may be provided in the aqueous capture ammonia using any convenient protocol. In some instances, the cations present in the aqueous capture ammonia are derived from a geomass used in regeneration of the aqueous capture ammonia from an aqueous ammonium salt. In addition and/or alternatively, the cations may be provided by combining an aqueous capture ammonia with a cation source, e.g., as described above. Further details regarding such embodiments may be found in U.S. Pat. No. 11,946,343, the disclosure of which is herein incorporated by reference.

Other CO₂ sequestering carbonate slurry production protocols that may be employed include alkaline intensive protocols, in which a CO₂ containing gas is contacted with an aqueous medium at pH of about 10 or more. As such, carbonate slurries employed in methods of the invention may also be prepared using non-CO₂ sequestering protocols, such as protocols in which a soluble metal cation reactant and a soluble carbonate anion reactant are combined under conditions sufficient to precipitate a solid metal carbonate. Examples of such protocols include, but are not limited to, those described in U.S. Pat. Nos. 8,333,944; 8,177,909; 8,137,455; 8,114,214; 8,062,418; 8,006,446; 7,939,336; 7,931,809; 7,922,809; 7,914,685; 7,906,028; 7,887,694; 7,829,053; 7,815,880; 7,771,684; 7,753,618; 7,749,476; 7,744,761; and 7,735,274; the disclosures of which are herein incorporated by reference.

In some embodiments an additive is present in the cation source and/or in the aqueous ammonia capture liquid regenerated from the aqueous ammonium salt, e.g., as described below. Additives may include, e.g., ionic species such as magnesium (Mg²⁺), strontium (Sr²⁺), barium (Ba²⁺), radium (Ra²⁺), ammonium (NH₄⁺), sulfate (SO₄²⁻), phosphates (PO₄³⁻, HPO₄²⁻, or H₂PO₄⁻), carboxylate groups such as, e.g., oxylate, carbamate groups such as, e.g., H₂NCOO⁻, transition metal cations such as, e.g., manganese (Mn), copper (Cu), nickel (Ni), zinc (Zn), cadmium (Cd), chromium (Cr). In some instances, the additives are intentionally added to the cation source and/or to the aqueous ammonia capture liquid regenerated from the aqueous ammonium salt. In other instances, the additives are extracted from an alkalinity source, e.g., from geomass such as described above, during some embodiments of the method. In some embodiments the additive has an effect on the reactivity of the CO₂ sequestering carbonate precipitate, for example, in some instances, the calcium carbonate slurry has no detectable calcite morphology, and may be amorphous calcium carbonate (ACC), vaterite, aragonite or other morphology, including any combination of such morphologies.

Aspects of the methods include preparing a carbonate slurry from a precipitation reaction mixture having predetermined conditions selected to produce an aggregate having desirable durability or friability. In such instances, the carbonate slurry, e.g., as described above, is prepared using precipitation conditions that ultimate yield aggregates having desired durability or friability. As such, the precipitation reaction conditions that are selected in a given embodiment of the invention are conditions known to produce aggregates with desired durability of friable. Accordingly, in some instances the selected precipitation reaction conditions are known to produce durable aggregates. In other instances, the selected precipitation reaction conditions are known to produce friable aggregates.

In some embodiments, e.g., where the desired aggregate is durable, the precipitation reaction mixture conditions are selected that favor a single amorphous calcium phosphate (ACC) crystallization event. In certain of such embodiments, the precipitation conditions include precipitation at a pH of less than 8, e.g., a pH ranging from 7 to 7.9. Accordingly, embodiments of the invention include obtaining a carbonate slurry from a precipitation reaction mixture having a pH of less than 8, such as 7 to 7.9, e.g., where the production of durable aggregates is desired. In such embodiments, the desired pH may be provided using any convenient protocol, where protocols of interest that provide for a pH of less than 8 include, but are not limited to 7 to 7.9 and the like.

In some embodiments, e.g., where the desired aggregate is friable, the precipitation reaction mixture conditions are selected that favor a plurality of, i.e., two or more (e.g., two), amorphous calcium phosphate (ACC) crystallization events. In certain of such embodiments, the precipitation conditions include precipitation at a pH of 8 or higher. Accordingly, embodiments of the invention include obtaining a carbonate slurry from a precipitation reaction mixture having a pH of 8 or higher, e.g., where the production of durable aggregates is friable. In such embodiments, the desired pH may be provided using any convenient protocol, where protocols of interest that provide for a pH of 8 or higher include, but are not limited to 8.1 to 8.5 and the like.

The product carbonate compositions may vary greatly. The precipitated product may include one or more different carbonate compounds, such as two or more different carbonate compounds, e.g., three or more different carbonate compounds, five or more different carbonate compounds, etc., including non-distinct, amorphous carbonate compounds. Carbonate compounds of precipitated products of the invention may be compounds having a molecular formulation Xₘ(CO₃)ₙ where X is any element or combination of elements that can chemically bond with a carbonate group or its multiple, wherein X is in certain embodiments an alkaline earth metal and not an alkali metal; wherein m and n are stoichiometric positive integers. These carbonate compounds may have a molecular formula of Xₘ(CO₃)ₙ·H₂O, where there are one or more structural waters in the molecular formula. The amount of carbonate in the product, as determined by coulometry using the protocol described as coulometric titration, may be 40% or higher, such as 70% or higher, including 80% or higher.

The carbonate compounds of the precipitated products may include a number of different cations, such as but not limited to ionic species of: calcium, magnesium, sodium, potassium, sulfur, boron, silicon, strontium, and combinations thereof. Of interest are carbonate compounds of divalent metal cations, such as calcium and magnesium carbonate compounds. Specific carbonate compounds of interest include, but are not limited to: calcium carbonate minerals, magnesium carbonate minerals and calcium magnesium carbonate minerals. Calcium carbonate minerals of interest include, but are not limited to: calcite (CaCO₃), aragonite (CaCO₃), vaterite (CaCO₃), ikaite (CaCO₃·6H₂O), and amorphous calcium carbonate (CaCO₃). Magnesium carbonate minerals of interest include, but are not limited to magnesite (MgCO₃), barringtonite (MgCO₃·2H₂O), nesquehonite (MgCO₃·3H₂O), lanfordite (MgCO₃·5H₂O), hydromagnisite, and amorphous magnesium calcium carbonate (MgCO₃). Calcium magnesium carbonate minerals of interest include, but are not limited to dolomite (CaMg)(CO₃)₂), huntite (Mg₃Ca(CO₃)₄) and sergeevite (Ca₂Mg₁₁(CO₃)₁₃·H₂O). Also of interest are carbonate compounds formed with Na, K, Al, Ba, Cd, Co, Cr, As, Cu, Fe, Pb, Mn, Hg, Ni, V, Zn, etc. The carbonate compounds of the product may include one or more waters of hydration, or may be anhydrous. In some instances, the amount by weight of magnesium carbonate compounds in the precipitate exceeds the amount by weight of calcium carbonate compounds in the precipitate. For example, the amount by weight of magnesium carbonate compounds in the precipitate may exceed the amount by weight calcium carbonate compounds in the precipitate by 5% or more, such as 10% or more, 15% or more, 20% or more, 25% or more, 30% or more. In some instances, the weight ratio of magnesium carbonate compounds to calcium carbonate compounds in the precipitate ranges from 1.5-5 to 1, such as 2-4 to 1 including 2-3 to 1. In some instances, the precipitated product may include hydroxides, such as divalent metal ion hydroxides, e.g., calcium and/or magnesium hydroxides.

Further details regarding carbonate production and methods of using the carbonated produced thereby are provided in: U.S. Pat. Nos. 10,711,236; 10,203,434; 10,197,747; 9,993,799; 9,707,513 and 9,714,406; the disclosures of which are herein incorporated by reference.

Where desired the carbonate slurry may be washed one or more times. Where desired, one or more additives may be introduced into the carbonate slurry. In some instances, the slurry may be prepared through rewetting of a dried carbonate composition, such as a dried carbonate powder.

Producing a Carbonate Aggregate from the Carbonate Slurry

Following production of a carbonate slurry, e.g., as described above, the carbonate slurry is subjected to rotational action. Rotational action is meant that the carbonate slurry is moved around an axis. The rate of rotational movement about the axis may vary, where in some instances the rate of rotational movement ranges from 6 to 55 rpm, such that aggregates closer to the rotational axis experience less centripetal force and aggregates further away from the rotational axis may experience higher centripetal force. Importantly, the rotational action to which the slurry is subjected is not the rotational action that would be provided by a centrifuge. As such, the rotational action is not sufficient to substantially separate water from the calcium phosphate particles of the slurry. In other words, the methods do not include subjecting the carbonate slurry to centrifugation. Any convenient device may be employed to subject the carbonate slurry to rotational action. Devices of interest include, but are not limited to: a rotary dryer, a rotary cooler, an agglomerator, a rotary kiln, a coating drum, a conditioning drum or a balling drum, a tramel, a pan mixer, a volumetric concrete mixer and the like.

In some instances, the freshly precipitated calcium carbonate solids, also containing both structural-bound water and liquid water, with a non-newtonian flow properties, is placed into the drum of a rotary concrete mixer. To remove the liquid and dry the calcium carbonate solids, a heated air flow can be applied at 88 F (range: 68 F to 110 F) during the beginning of the agglomeration process in the rotary drum, or for the duration of the process. When the calcium carbonate has been shaped into aggregates, and the aggregates no longer have viscoelastic or flow behavior, and have a desired moisture content of typically 20% w/w (range: 15-28%) they are removed from the drum.

The carbonate slurry may be introduced into a rotational action device, e.g., revolving drum, and mixed in the rotational action device under conditions sufficient to produce a carbonate aggregate. In some instances, the carbonate slurry is introduced into the rotational action device, e.g., revolving drum, with an aggregate substrate and then mixed in the rotational action device, e.g., revolving drum, to produce a carbonate coated aggregate. In some instances, the slurry (and substrate) are introduced into the rotational action device, e.g., revolving drum, and mixing is commenced shortly after production of the carbonate slurry, such as within 12 hours, such as within 6 hours and including within 4 hours of preparing the carbonate slurry. In some instances, the entire process (i.e., from commencement of slurry preparation to obtainment of carbonate aggregate product) is performed in 15 hours or less, such as 10 hours or less, including 5 hours or less, e.g., 3 hours or less, including 1 hour less.

When employed, any convenient aggregate substrate may be used. Examples of suitable aggregate substrates include, but are not limited to: natural mineral aggregate materials, e.g., carbonate rocks, sand (e.g., natural silica sand), sandstone, gravel, granite, diorite, gabbro, basalt, etc.; and synthetic aggregate materials, such as industrial byproduct aggregate materials, e.g., blast-furnace slag, fly ash, municipal waste, and recycled concrete, etc. In these instances, the aggregate substrate includes a material that is different from the particles of the carbonate slurry. In other instances, the substrate may be the aggregate formed from the process described herein from an earlier production. In some cases, that like substrate may be an agglomeration of non-carbonate particles agglomerated together with the carbonate slurry in the earlier production cycle, especially when finer core substrate grains are employed. Such agglomerated composite substrates may have certain benefits, such as having a light weigh characteristic, bestowing the final aggregate with properties suitable for light weight concrete, or have a greater proportion of the aggregate comprising CO₂-sequestered carbonate, increase the CO₂ sequestration potential of the aggregate when deployed in concrete, thus lowering the embodied CO₂ of the concrete in a lifecycle analysis.

The carbonate slurry, and aggregate substrate when present, is mixed in the rotational action device, e.g., revolving drum, for a period of time sufficient to produce the desired carbonate aggregate. While the period of time may vary, in some instances the period of time ranges from 10 min to 5 hours, such as 15 min to 3 hours or more. Where the carbonate slurry is mixed with an aggregate substrate in a rotational action device, e.g., revolving drum, the resultant carbonate aggregate is a carbonate coated aggregate, where the particulate members of the aggregate include a core material at least partially, if not completely, coated by a carbonate material. In some cases, especially with finer core grains, the carbonate slurry binds more than one particle of core material together into an agglomerated composite.

During and/or following mixing, the resultant carbonate aggregate may be dried. Where desired, drying may be achieved using any convenient protocol. In some instances, drying the resultant carbonate aggregate may occur during production, e.g., by application of heat during mixing. Such protocols include, e.g., direct heating of the mixing vessel, e.g., using waste energy to supply the heat, or, e.g., heating the inside of the mixing vessel with, e.g., hot flue gas from a fossil fuel combustion process, so that the temperature of the internal atmosphere where the carbonate aggregate is being produced is between 15° C. and 260° C., or between 15° C. and 30° C., or 15° C. and 50° C., or 15° C. and 200° C., or between or 20° C. and 200° C., such as 20° C. and 60° C., or 25° C. and 75° C., or 25° C. and 150° C., or between 30° C. and 250° C., such as 30° C. and 150° C., or 30° C. and 200° C., and including between 40° C. and 250° C., to dry the carbonate aggregate. In other instances, drying the resultant carbonate aggregate may occur after production, e.g., after the aggregate has exited the mixing and/or aggregate production vessel. Convenient protocols include drying the resultant carbonate aggregate in open atmosphere under ambient conditions, e.g., outside in an aggregate storage bay and/or silo at a production plant or, e.g., in a covered dome or enclosed container away from outside elements. In some instances of the embodiment, the method of drying may include curing the resultant aggregate, e.g., as described below. In other instances of the embodiment, the method may not involve drying the resultant carbonate aggregate.

Where desired, the methods may include curing the resultant aggregate product, which is specific to the portion of the aggregate product that is comprised of the carbonate that came from the slurry. If no substrate is present, then the curing may occur within the carbonate itself. If substrate and/or composite is present, then the curing may occur within both the carbonate itself, but also between the carbonate and the other material that is present. The method of curing may take place in open air, in water, in water with added chemicals, in air then in water, in a temperature & humidity controlled chamber, under UV, microwave or other form of radiation, or even in the drum itself during production of the carbonate aggregate, as desired. Time to cure ranges from several seconds if using radiation, to several minutes if happening in the drum during production, to hours or even days if curing in air, water, etc. Another aspect of the curing is the morphology of the CO₂ sequestered carbonate precipitate. For example, for CO₂ sequestered carbonate precipitate that is comprised of calcium carbonate, the vaterite morphology is observed at the slurry stage and in early curing stages, along with amorphous calcium carbonate (ACC) phases. As the carbonate aggregate cures and effectively dehydrates, aragonite and calcite begin to form, and the ACC phases disappear.

Where the carbonate slurry is mixed with an aggregate substrate in a revolving drum, the resultant carbonate aggregate is a carbonate coated aggregate, where the particulate members of the aggregate include a core material at least partially, if not completely, coated by a carbonate material. In some cases, especially with finer core grains, the carbonate slurry binds more than one particle of core material together into an agglomerated composite.

Where the carbonate coating is produced using a CO₂ sequestering process, e.g., as described above, the resultant aggregate compositions may be considered to be CO₂ sequestering aggregate compositions. In some instances, the CO₂ sequestering aggregate compositions include aggregate particles having a core and a CO₂ sequestering carbonate coating on at least a portion of a surface of the core. The CO₂ sequestering carbonate coating is made up of a CO₂ sequestering carbonate material. By “CO₂ sequestering carbonate material” is meant a material that stores a significant amount of CO₂ in a storage-stable format, such that CO₂ gas is not readily produced from the material and released into the atmosphere. In certain embodiments, the CO₂-sequestering material includes 5% or more, such as 10% or more, including 25% or more, for instance 50% or more, such as 75% or more, including 90% or more of CO₂, e.g., present as one or more carbonate compounds. In additional embodiments, the CO₂-sequestering material may form independent particles of 100% without a substrate particle. The CO₂-sequestering materials present in coatings in accordance with the invention may include one or more carbonate compounds, e.g., as described in greater detail below. The amount of carbonate in the CO₂-sequestering material, e.g., as determined by coulometry, may be 10% or higher, 20% or higher 40% or higher, such as 70% or higher, including 80% or higher, such as 100% when the particle form without a core substrate, or the core substrate is a particle that formed without a core substrate.

CO₂ sequestering materials, e.g., as described herein, provide for long-term, or permanent, storage of CO₂ in a manner such that CO₂ is sequestered (i.e., fixed) in the material, where the sequestered CO₂ does not become part of the atmosphere. When the material is maintained under conditions conventional for its intended use, the material keeps sequestered CO₂ fixed for extended periods of time (e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer) without significant, if any, release of the CO₂ from the material. With respect to the CO₂-sequestering materials, when they are employed in a manner consistent with their intended use and over their lifetime, the amount of degradation, if any, as measured in terms of CO₂ gas release from the product will not exceed 1% per year, such as 0.5% per year, and in certain embodiments, 0.1% per year. In some instances, CO₂-sequestering materials provided by the invention do not release more than 1%, 5%, or 10% of their total CO₂ when exposed to normal conditions of temperature and moisture, including rainfall of normal pH, for there intended use, for at least 1, 2, 5, 10, or 20 years, or for more than 20 years, for example, for more than 100 years. Any suitable surrogate marker or test that is reasonably able to predict such stability may be used. For example, an accelerated test comprising conditions of elevated temperature and/or moderate to more extreme pH conditions is reasonably able to indicate stability over extended periods of time. For example, depending on the intended use and environment of the composition, a sample of the composition may be exposed to 50, 75, 90, 100, 120, or 150° C. for 1, 2, 5, 25, 50, 100, 200, or 500 days at between 10% and 50% relative humidity, and a loss less than 1%, 2%, 3%, 4%, 5%, 10%, 20%, 30%, or 50% of its carbon may be considered sufficient evidence of stability of materials of the invention for a given period (e.g., 1, 10, 100, 1000, 1,000,000, 1,000,000,000 or more than 1,000,000,000 years, such as the pre-Cambrian limestones and dolostones in Earth's lithospheric crust).

The CO₂ sequestering carbonate material that is present in coatings of the coated particles of the subject aggregate compositions may vary. In some instances, the carbonate material is a highly reflective microcrystalline/amorphous carbonate material. The microcrystalline/amorphous materials present in coatings of the invention may be highly reflective. As the materials may be highly reflective, the coatings that include the same may have a high total surface reflectance (TSR) value. TSR may be determined using any convenient protocol, such as ASTM E1918 Standard Test Method for Measuring Solar Reflectance of Horizontal and Low-Sloped Surfaces in the Field (see also R. Levinson, H. Akbari, P. Berdahl, Measuring solar reflectance—Part II: review of practical methods, LBNL 2010). In some instances, the backsheets exhibit a TSR value ranging from R_{g},0=0.0 to R_{g},0=1.0, such as R_{g},0=0.25 to R_{g},0=0.99, including R_{g},0=0.40 to R_{g},0=0.98, e.g., as measured using the protocol referenced above.

In some instances, the coatings that include the carbonate materials are highly reflective of near infra-red (NIR) light, ranging in some instances from 10 to 99%, such as 50 to 99%. By NIR light is meant light having a wavelength ranging from 700 nanometers (nm) to 2.5 mm. NIR reflectance may be determined using any convenient protocol, such as ASTM C1371—04a(2010)e1 Standard Test Method for Determination of Emittance of Materials Near Room Temperature Using Portable Emissometers (http://www.astm.org/Standards/C1371.htm) or ASTM G173—03(2012) Standard Tables for Reference Solar Spectral Irradiances: Direct Normal and Hemispherical on 37° Tilted Surface (http://rredc.nrel.gov/solar/spectra/am1.5/ASTMG173/ASTMG173.html). In some instances, the coatings exhibit a NIR reflectance value ranging from Rg;0=0.0 to Rg;0=1.0, such as Rg;0=0.25 to Rg;0=0.99, including Rg;0=0.40 to Rg;0=0.98, e.g., as measured using the protocol referenced above.

In some instances, the carbonate coatings are highly reflective of ultra-violet (UV) light, ranging in some instances from 10 to 99%, such as 50 to 99%. By UV light is meant light having a wavelength ranging from 400 nm and 10 nm. UV reflectance may be determined using any convenient protocol, such as ASTM G173—03(2012) Standard Tables for Reference Solar Spectral Irradiances: Direct Normal and Hemispherical on 37° Tilted Surface. In some instances, the materials exhibit a UV value ranging from R_{g},0=0.0 to R_{g},0=1.0, such as R_{g},0=0.25 to R_{g},0=0.99, including R_{g},0=0.4 to R_{g},0=0.98, e.g., as measured using the protocol referenced above.

In some instances, the coatings are reflective of visible light, e.g., where reflectivity of visible light may vary, ranging in some instances from 10 to 99%, such as 10 to 90%. By visible light is meant light having a wavelength ranging from 380 nm to 740 nm. Visible light reflectance properties may be determined using any convenient protocol, such as ASTM G173—03(2012) Standard Tables for Reference Solar Spectral Irradiances: Direct Normal and Hemispherical on 37° Tilted Surface. In some instances, the coatings exhibit a visible light reflectance value ranging from R_{g},0=0.0 to R_{g},0=1.0, such as R_{g},0=0.25 to R_{g},0=0.99, including R_{g},0=0.4 to R_{g},0=0.98, e.g., as measured using the protocol referenced above.

The materials making up the carbonate components are, in some instances, amorphous or microcrystalline. Where the materials are microcrystalline, the crystal size, e.g., as determined using the Scherrer equation applied to the FWHM of X-ray diffraction pattern, is small, and in some instances is 1000 microns or less in diameter, such as 100 microns or less in diameter, and including 10 microns or less in diameter. In some instances, the crystal size ranges in diameter from 1000 μm to 0.001 μm, such as 10 to 0.001 μm, including 1 to 0.001 μm. In some instances, the crystal size is chosen in view of the wavelength(s) of light that are to be reflected. For example, where light in the visible spectrum is to be reflected, the crystal size range of the materials may be selected to be less than one-half the “to be reflected” range, so as to give rise to photonic band gap. For example, where the to be reflected wavelength range of light is 100 to 1000 nm, the crystal size of the material may be selected to be 50 nm or less, such as ranging from 1 to 50 nm, e.g., 5 to 25 nm. In some embodiments, the materials produced by methods of the invention may include rod-shaped crystals and amorphous solids. The rod-shaped crystals may vary in structure, and in certain embodiments have length to diameter ratio ranging from 500 to 1, such as 10 to 1. In certain embodiments, the length of the crystals ranges from 0.5 μm to 500 μm, such as from 5 μm to 100 μm. In yet other embodiments, substantially completely amorphous solids are produced.

The density, porosity, and permeability of the coating materials may vary according to the application. With respect to density, while the density of the material may vary, in some instances the density ranges from 5 g/cm³ to 0.01 g/cm³, such as 3 g/cm³ to 0.3 g/cm³ and including 2.7 g/cm³ to 0.4 g/cm³. With respect to porosity, as determined by Gas Surface Adsorption as determined by the BET method (Brown Emmett Teller (e.g., as described at http://en.wikipedia.org/wiki/BET_theory, S. Brunauer, P. H. Emmett and E. Teller, J. Am. Chem. Soc., 1938, 60, 309. doi:10.1021/ja01269a023) the porosity may range in some instances from 100 m²/g to 0.1 m²/g, such as 60 m²/g to 1 m²/g and including 40 m²/g to 1.5 m²/g. With respect to permeability, in some instances the permeability of the material may range from 0.1 to 100 darcies, such as 1 to 10 darcies, including 1 to 5 darcies (e.g., as determined using the protocol described in H. Darcy, Les Fontaines Publiques de la Ville de Dijon, Dalmont, Paris (1856).). Permeability may also be characterized by evaluating water absorption of the material. As determined by water absorption protocol, e.g., the water absorption of the material ranges, in some embodiments, from 0 to 25%, such as 1 to 15% and including from 2 to 9%.

The hardness of the materials may also vary. In some instances, the materials exhibit a Mohs hardness of 3 or greater, such as 5 or greater, including 6 or greater, where the hardness ranges in some instances from 3 to 8, such as 4 to 7 and including 5 to 6 Mohs (e.g., as determined using the protocol described in American Federation of Mineralogical Societies. “Mohs Scale of Mineral Hardness”). Hardness may also be represented in terms of tensile strength, e.g., as determined using the protocol described in ASTM C1167. In some such instances, the material may exhibit a compressive strength of 100 to 3000 N, such as 400 to 2000 N, including 500 to 1800 N.

As reviewed above, carbonate coatings of the invention include one or more carbonate materials. By carbonate material is meant a material or composition that includes one or more carbonate compounds, such as two or more different carbonate compounds, e.g., three or more different carbonate compounds, five or more different carbonate compounds, etc., including non-distinct, amorphous carbonate compounds. Carbonate compounds of interest may be compounds having a molecular formulation Xₘ(CO₃)ₙ where X is any element or combination of elements that can chemically bond with a carbonate group or its multiple, wherein X is in certain embodiments an alkaline earth metal and not an alkali metal; wherein m and n are stoichiometric positive integers. These carbonate compounds may have a molecular formula of Xₘ(CO₃)ₙ·H₂O, where there are one or more structural waters in the molecular formula. The amount of carbonate in the carbonate compounds of the carbonate material, as determined by coulometry using the protocol described as coulometric titration, may be 40% or higher, such as 70% or higher, including 80% or higher. Carbonate compounds of interest are those having a reflectance value across the visible spectrum of 0.05 or greater, such as 0.6 or greater, 0.7 or greater, 0.8 or greater, 0.9 or greater, including 0.95 or greater.

The carbonate compounds may include a number of different cations, such as but not limited to ionic species of: calcium, magnesium, sodium, potassium, sulfur, boron, silicon, strontium, and combinations thereof. Of interest are carbonate compounds of divalent metal cations, such as calcium and magnesium carbonate compounds. Specific carbonate compounds of interest include, but are not limited to: calcium carbonate minerals, magnesium carbonate minerals and calcium magnesium carbonate minerals. Calcium carbonate minerals of interest include, but are not limited to: calcite (CaCO₃), aragonite (CaCO₃), amorphous vaterite precursor/anhydrous amorphous carbonate (CaCO₃), vaterite (CaCO₃), ikaite (CaCO₃·6H₂O), and amorphous calcium carbonate (CaCO₃). Magnesium carbonate minerals of interest include, but are not limited to magnesite (MgCO₃), barringtonite (MgCO₃·2H₂O), nesquehonite (MgCO₃·3H₂O), lanfordite (MgCO₃·5H₂O), hydromagnisite, and amorphous magnesium calcium carbonate (MgCaCO₃). Calcium magnesium carbonate minerals of interest include, but are not limited to dolomite (CaMg)(CO₃)₂), huntite (Mg₃Ca(CO₃)₄) and sergeevite (Ca₂Mg₁₁(CO₃)₁₃·H₂O). Also of interest are bicarbonate compounds, e.g., sodium bicarbonate, potassium bicarbonate, etc. The carbonate compounds may include one or more waters of hydration, or may be anhydrous. In some instances, the amount by weight of magnesium carbonate compounds in the precipitate exceeds the amount by weight of calcium carbonate compounds in the precipitate. For example, the amount by weight of magnesium carbonate compounds in the precipitate may exceed the amount by weight calcium carbonate compounds in the precipitate by 5% or more, such as 10% or more, 15% or more, 20% or more, 25% or more, 30% or more. In some instances, the weight ratio of magnesium carbonate compounds to calcium carbonate compounds in the precipitate ranges from 1.5-5 to 1, such as 2-4 to 1 including 2-3 to 1.

In some instances, the carbonate material may further include hydroxides, such as divalent metal ion hydroxides, e.g., calcium and/or magnesium hydroxides. The carbonate compounds may include one or more components that serve as identifying components, where these one more components may identify the source of the carbonate compounds. For example, identifying components that may be present in product carbonate compound compositions include, but are not limited to: chloride, sodium, sulfur, potassium, bromide, silicon, strontium, magnesium and the like. Any such source-identifying or “marker” elements are generally present in small amounts, e.g., in amounts of 20,000 ppm or less, such as amounts of 2000 ppm or less. In certain embodiments, the “marker” compound is strontium, which may be present in the precipitate incorporated into the aragonite lattice, and make up 10,000 ppm or less, ranging in certain embodiments from 3 to 10,000 ppm, such as from 5 to 5000 ppm, including 5 to 1000 ppm, e.g., 5 to 500 ppm, including 5 to 100 ppm. Another “marker” compound of interest is magnesium, which may be present in amounts of up to 20% mole substitution for calcium in carbonate compounds. The identifying component of the compositions may vary depending on the particular medium source, e.g., ocean water, lagoon water, brine, etc. In certain embodiments, the calcium carbonate content of the carbonate material is 25% w/w or higher, such as 40% w/w or higher, and including 50% w/w or higher, e.g., 60% w/w. The carbonate material has, in certain embodiments, a calcium/magnesium ratio that is influenced by, and therefore reflects, the water source from which it has been precipitated. In certain embodiments, the calcium/magnesium molar ratio ranges from 10/1 to 1/5 Ca/Mg, such as 5/1 to 1/3 Ca/Mg. In certain embodiments, the carbonate material is characterized by having a water source identifying carbonate to hydroxide compound ratio, where in certain embodiments this ratio ranges from 100 to 1, such as 10 to 1 and including 1 to 1. In some instances, the carbonate material may further include one or more additional types of non-carbonate compounds, such as but not limited to: silicates, sulfates, sulfites, phosphates, arsenates, etc.

In some embodiments, the carbonate material includes one or more contaminants predicted not to leach into the environment by one or more tests selected from the group consisting of Toxicity Characteristic Leaching Procedure, Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. Tests and combinations of tests may be chosen depending upon likely contaminants and storage conditions of the composition. For example, in some embodiments, the composition may include As, Cd, Cr, Hg, and Pb (or products thereof), each of which might be found in a waste gas stream of a coal-fired power plant. Since TCLP tests for As, Ba, Cd, Cr, Pb, Hg, Se, and Ag, TCLP may be an appropriate test for aggregates described herein. In some embodiments, a carbonate composition of the invention includes As, wherein the composition is predicted not to leach As into the environment. For example, a TCLP extract of the composition may provide less than 5.0 mg/L As indicating that the composition is not hazardous with respect to As. In some embodiments, a carbonate composition of the invention includes Cd, wherein the composition is predicted not to leach Cd into the environment. For example, a TCLP extract of the composition may provide less than 1.0 mg/L Cd indicating that the composition is not hazardous with respect to Cd. In some embodiments, a carbonate composition of the invention includes Cr, wherein the composition is predicted not to leach Cr into the environment. For example, a TCLP extract of the composition may provide less than 5.0 mg/L Cr indicating that the composition is not hazardous with respect to Cr. In some embodiments, a carbonate composition of the invention includes Hg, wherein the composition is predicted not to leach Hg into the environment. For example, a TCLP extract of the composition may provide less than 0.2 mg/L Hg indicating that the composition is not hazardous with respect to Hg. In some embodiments, a carbonate composition of the invention includes Pb, wherein the composition is predicted not to leach Pb into the environment. For example, a TCLP extract of the composition may provide less than 5.0 mg/L Pb indicating that the composition is not hazardous with respect to Pb. In some embodiments, a carbonate composition and aggregate that includes of the same of the invention may be non-hazardous with respect to a combination of different contaminants in a given test. For example, the carbonate composition may be non-hazardous with respect to all metal contaminants in a given test. A TCLP extract of a composition, for instance, may be less than 5.0 mg/L in As, 100.0 mg/L in Ba, 1.0 mg/L in Cd, 5.0 mg/mL in Cr, 5.0 mg/L in Pb, 0.2 mg/L in Hg, 1.0 mg/L in Se, and 5.0 mg/L in Ag. Indeed, a majority if not all of the metals tested in a TCLP analysis on a composition of the invention may be below detection limits. In some embodiments, a carbonate composition of the invention may be non-hazardous with respect to all (e.g., inorganic, organic, etc.) contaminants in a given test. In some embodiments, a carbonate composition of the invention may be non-hazardous with respect to all contaminants in any combination of tests selected from the group consisting of Toxicity Characteristic Leaching Procedure, Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. As such, carbonate compositions and aggregates including the same of the invention may effectively sequester CO₂ (e.g., as carbonates, bicarbonates, or a combinations thereof) along with various chemical species (or co-products thereof) from waste gas streams, industrial waste sources of divalent cations, industrial waste sources of proton-removing agents, or combinations thereof that might be considered contaminants if released into the environment. Compositions of the invention incorporate environmental contaminants (e.g., metals and co-products of metals such as Hg, Ag, As, Ba, Be, Cd, Co, Cr, Cu, Mn, Mo, Ni, Pb, Sb, Se, Tl, V, Zn, or combinations thereof) in a non-leachable form.

As reviewed above, the carbonate material is a CO₂ sequestering carbonate material. By “CO₂ sequestering” is meant that the material has been produced from CO₂, e.g., that is derived from a fuel source used by humans, including atmospheric CO₂ that may be derived from human activities, or from natural sources, such as plant decay by microorganisms, where the mixture of human-derived fossil fuel CO₂ from combustion of fossil fuel and that from decay both have a plant derived source where the CO₂ was originally derived from photosynthesis. For example, in some embodiments, a CO₂ sequestering material is produced from CO₂ that is obtained from the combustion of a fossil fuel, e.g., in the production of electricity. Examples of sources of such CO₂ include, but are not limited to, power plants, industrial manufacturing plants, etc., which combust fossil fuels and produce CO₂, e.g., in the form of a CO₂ containing gas or gases. Examples of fossil fuels include, but are not limited to, oils, coals, natural gasses, tar sands, rubber tires, biomass, shred, etc. Further details on how to produce a CO₂ sequestering material are provided below.

The CO₂ sequestering materials may have an isotopic profile that identifies the component as being of fossil fuel origin or from modern plants, both fractionating the CO₂ during photosynthesis, and therefore as being CO₂ sequestering. For example, in some embodiments the carbon atoms in the CO₂ materials reflect the relative carbon isotope composition (δ¹³C) of the fossil fuel (e.g., coal, oil, natural gas, tar sand, trees, grasses, agricultural plants) from which the plant-derived CO₂, both fossil or modern, that was used to make the material was derived. In addition to, or alternatively to, carbon isotope profiling, other isotopic profiles, such as those of oxygen (δ¹⁸O), nitrogen (δ⁵¹N), sulfur (δ³⁴S), and other trace elements may also be used to identify a fossil fuel source that was used to produce an industrial CO₂ source from which a CO₂ sequestering material is derived. For example, another marker of interest is (δ¹⁸O). Isotopic profiles that may be employed as an identifier of CO₂ sequestering materials of the invention are further described in U.S. patent application Ser. No. 14/112,495 published as United States Patent Application Publication No. 2014/0234946; the disclosure of which is herein incorporated by reference.

As reviewed above, aggregate compositions of the invention include particles having a core region or regions and a CO₂ sequestering carbonate coating on at least a portion of a surface of the core, and in case of several core particles, connecting the core particles to form an agglomerate. The coating may cover 10% or more, 20% or more, 30% or more, 40% or more, 50% or more, 60% or more, 70% or more, 80% or more, 90% or more, including 95% or more of the surface of the core particle or particles. The thickness of the carbonate layer may vary, as desired. In some instances, the thickness may range from 0.1 μm to 25 mm, such as 1 μm to 1000 μm, including 10 μm to 500 μm.

The core of the coated particles of the aggregate compositions described herein may vary widely. The core may be made up of any convenient aggregate material. Examples of suitable aggregate materials include, but are not limited to: natural mineral aggregate materials, e.g., carbonate rocks, sand (e.g., natural silica sand), sandstone, gravel, granite, diorite, gabbro, basalt, etc.; and synthetic aggregate materials, such as industrial byproduct aggregate materials, e.g., blast-furnace slag, fly ash, municipal waste, and recycled concrete, carbonate slurry agglomerates, etc. In some instances, the core comprises a material that is different from the carbonate coating.

The physical properties of the coated particles of the aggregate compositions and agglomerated aggregate composite particles may vary. Aggregates of the invention have a density that may vary so long as the aggregate provides the desired properties for the use for which it will be employed, e.g., for the building material in which it is employed. In certain instances, the density of the aggregate particles ranges from 0.6 to 5 gm/cc, such as 1.1 to 5 gm/cc, such as 1.3 gm/cc to 3.15 gm/cc, and including 1.8 gm/cc to 2.7 gm/cc. Other particle densities in embodiments of the invention, e.g., for lightweight aggregates, may range from 1.1 to 2.2 gm/cc, e.g., 1.2 to 2.0 g/cc or 1.4 to 1.8 g/cc. In some embodiments the invention provides aggregates that range in bulk density (unit weight) from 50 lb/lb/ft³ to 200 lb/ft³, or 75 lb/ft³ to 175 lb/ft³, or 50 lb/ft³ to 100 lb/ft³, or 75 lb/ft³ to 125 lb/ft³, or lb/ft³ to 115 lb/ft³, or 100 lb/ft³ to 200 lb/ft³, or 125 lb/ft³ to lb/ft³, or 140 lb/ft³ to 160 lb/ft³, or 50 lb/ft³ to 200 lb/ft³. Some embodiments of the invention provide lightweight aggregate, e.g., aggregate that has a bulk density (unit weight) of 75 lb/ft³ to 125 lb/ft³, such as 90 lb/ft³ to 115 lb/ft³.

The hardness of the aggregate particles making up the aggregate compositions of the invention may also vary, and in certain instances the hardness, expressed on the Mohs scale, ranges from 1.0 to 9, such as 1 to 7, including 1 to 6 or 1 to 5. In some embodiments, the Mohr's hardness of aggregates of the invention ranges from 2-5, or 2-4. In some embodiments, the Mohs hardness ranges from 2-6. Other hardness scales may also be used to characterize the aggregate, such as the Rockwell, Vickers, or Brinell scales, and equivalent values to those of the Mohs scale may be used to characterize the aggregates of the invention; e.g., a Vickers hardness rating of 250 corresponds to a Mohs rating of 3; conversions between the scales are known in the art.

The abrasion resistance of an aggregate may also be important, e.g., for use in a roadway surface, where aggregates of high abrasion resistance are useful to keep surfaces from polishing. Abrasion resistance is related to hardness but is not the same. Aggregates of the invention include aggregates that have an abrasion resistance similar to that of natural limestone, or aggregates that have an abrasion resistance superior to natural limestone, as well as aggregates having an abrasion resistance lower than natural limestone, as measured by art accepted methods, such as ASTM C131-03. In some embodiments aggregates of the invention have an abrasion resistance of less than 50%, or less than 40%, or less than 35%, or less than 30%, or less than 25%, or less than 20%, or less than 15%, or less than 10%, when measured by ASTM C131-03.

Aggregates of the invention may also have a porosity within a particular range. As will be appreciated by those of skill in the art, in some cases a highly porous aggregate is desired, in others an aggregate of moderate porosity is desired, while in other cases aggregates of low porosity, or no porosity, are desired. Porosities of aggregates of some embodiments of the invention, as measured by water uptake after oven drying followed by full immersion for 60 minutes, expressed as % dry weight, can be in the range of 1-40%, such as 2-20%, or 2-15%, including 2-10% or even 3-9%.

The dimensions of the aggregate particles may vary. Aggregate compositions of the invention are particulate compositions that may in some embodiments be classified as fine or coarse. Fine aggregates according to embodiments of the invention are particulate compositions that almost entirely pass through a Number 4 sieve (ASTM C 125 and ASTM C 33). Fine aggregate compositions according to embodiments of the invention have an average particle size ranging from 10 μm to 4.75 mm, such as 50 μm to 3.0 mm and including 75 μm to 2.0 mm. Coarse aggregates of the invention are compositions that are predominantly retained on a Number 4 sieve (ASTM C 125 and ASTM C 33). Coarse aggregate compositions according to embodiments of the invention are compositions that have an average particle size ranging from 4.75 mm to 200 mm, such as 4.75 to 150 mm in and including 5 to 100 mm. As used herein, “aggregate” may also in some embodiments encompass larger sizes, such as 3 in to 12 in or even 3 in to 24 in, or larger, such as 12 in to 48 in, or larger than 48 in.

### Concrete Dry Composites

Also provided are concrete dry composites that, upon combination with a suitable setting liquid (such as described below), produce a settable composition that sets and hardens into a concrete or a mortar. Concrete dry composites as described herein include an amount of a CO₂ sequestering aggregate, e.g., as described above, and a cement, such as a hydraulic cement. The term “hydraulic cement” is employed in its conventional sense to refer to a composition which sets and hardens after combining with water or a solution where the solvent is water, e.g., an admixture solution. Setting and hardening of the product produced by combination of the concrete dry composites of the invention with an aqueous liquid results from the production of hydrates that are formed from the cement upon reaction with water, where the hydrates are essentially insoluble in water.

Aggregates of the invention find use in place of conventional natural rock aggregates used in conventional concrete when combined with pure Portland cement. Other hydraulic cements of interest in certain embodiments are Portland cement blends. The phrase “Portland cement blend” includes a hydraulic cement composition that includes a Portland cement component and significant amount of a non-Portland cement component. As the cements of the invention are Portland cement blends, the cements include a Portland cement component. The Portland cement component may be any convenient Portland cement. As is known in the art, Portland cements are powder compositions produced by grinding Portland cement clinker (more than 90%), a limited amount of calcium sulfate which controls the set time, and up to 5% minor constituents (as allowed by various standards). When the exhaust gases used to provide carbon dioxide for the reaction contain SOx, then sufficient sulphate may be present as calcium sulfate in the precipitated material, either as a cement or aggregate to offset the need for additional calcium sulfate. As defined by the European Standard EN197.1, “Portland cement clinker is a hydraulic material which shall consist of at least two-thirds by mass of calcium silicates (3CaO·SiO₂ and 2CaO·SiO₂), the remainder consisting of aluminium- and iron-containing clinker phases and other compounds. The ratio of CaO to SiO₂ shall not be less than 2.0. The magnesium content (MgO) shall not exceed 5.0% by mass.” The concern about MgO is that later in the setting reaction, magnesium hydroxide, brucite, may form, leading to the deformation and weakening and cracking of the cement. In the case of magnesium carbonate containing cements, brucite will not form as it may with MgO. In certain embodiments, the Portland cement constituent of the present invention is any Portland cement that satisfies the ASTM Standards and Specifications of C150 (Types I-VIII) of the American Society for Testing of Materials (ASTM C50-Standard Specification for Portland Cement). ASTM C150 covers eight types of Portland cement, each possessing different properties, and used specifically for those properties.

Also of interest as hydraulic cements are carbonate containing hydraulic cements. Such carbonate containing hydraulic cements, methods for their manufacture and use are described in U.S. Pat. No. 7,735,274; the disclosure of which applications are herein incorporated by reference.

In certain embodiments, the hydraulic cement may be a blend of two or more different kinds of hydraulic cements, such as Portland cement and a carbonate containing hydraulic cement. In certain embodiments, the amount of a first cement, e.g., Portland cement in the blend ranges from 10 to 90% (w/w), such as 30 to 70% (w/w) and including 40 to 60% (w/w), e.g., a blend of 80% OPC and 20% carbonate hydraulic cement.

In some instances, the concrete dry composite compositions, as well as concretes produced therefrom, have a CarbonStar Rating (CSR) that is less than the CSR of the control composition that does not include an aggregate of the invention. The CarbonStar Rating (CSR) is a value that characterizes the embodied carbon (in the form of CaCO₃) for any product, in comparison to how carbon intensive production of the product itself is (i.e., in terms of the production CO₂). The CSR is a metric based on the embodied mass of CO₂ in a unit of concrete. Of the three components in concrete—water, cement and aggregate—cement is by far the most significant contributor to CO₂ emissions, roughly 1:1 by mass (1 ton cement produces roughly 1 ton CO2). So, if a cubic yard of concrete uses 600 lb cement, then its CSR is 600. A cubic yard of concrete according to embodiments of the present invention which include 600 lb cement and in which at least a portion of the aggregate is carbonate coated aggregate, e.g., as described above, will have a CSR that is less than 600, e.g., where the CSR may be 550 or less, such as 500 or less, including 400 or less, e.g., 250 or less, such as 100 or less, where in some instances the CSR may be a negative value, e.g., −100 or less, such as −500 or less including −1000 or less, where in some instances the CSR of a cubic yard of concrete having 600 lbs cement may range from 500 to −5000, such as −100 to −4000, including −500 to −3000. To determine the CSR of a given cubic yard of concrete that includes carbonate coated aggregate of the invention, an initial value of CO₂ generated for the production of the cement component of the concrete cubic yard is determined. For example, where the yard includes 600 lbs of cement, the initial value of 600 is assigned to the yard. Next, the amount of carbonate coating in the yard is determined. Since the molecular weight of carbonate is 100 a.u., and 44% of carbonate is CO₂, the amount of carbonate coating is present in the yard is then multiplied by 0.44 and the resultant value subtracted from the initial value in order to obtain the CSR for the yard. For example, where a given yard of concrete mix is made up of 600 lbs of cement, 300 lbs of water, 1429 lbs of fine aggregate and 1739 lbs of coarse aggregate, the weight of a yard of concrete is 4068 lbs and the CSR is 600. If 10% of the total mass of aggregate in this mix is replaced by carbonate coating, e.g., as described above, the amount of carbonate present in the revised yard of concrete is 317 lbs. Multiplying this value by 0.44 yields 139.5. Subtracting this number from 600 provides a CSR of 460.5.

### Settable Compositions

Settable compositions of the invention, such as concretes and mortars, are produced by combining a hydraulic cement with an amount of aggregate (fine for mortar, e.g., sand; coarse with or without fine for concrete) and water, either at the same time or by pre-combining the cement with aggregate, and then combining the resultant dry components with water. The choice of coarse aggregate material for concrete mixes using cement compositions of the invention may have a minimum size of about ⅜ inch and can vary in size from that minimum up to one inch or larger, including in gradations between these limits. Finely divided aggregate is smaller than ⅜ inch in size and again may be graduated in much finer sizes down to 200-sieve size or so. Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

The liquid phase, e.g., aqueous fluid, with which the dry component is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

In certain embodiments, the cements may be employed with one or more admixtures. Admixtures are compositions added to concrete to provide it with desirable characteristics that are not obtainable with basic concrete mixtures or to modify properties of the concrete to make it more readily useable or more suitable for a particular purpose or for cost reduction. As is known in the art, an admixture is any material or composition, other than the hydraulic cement, aggregate and water, that is used as a component of the concrete or mortar to enhance some characteristic, or lower the cost, thereof. The amount of admixture that is employed may vary depending on the nature of the admixture. In certain embodiments the amounts of these components range from 1 to 50% w/w, such as 2 to 10% w/w.

Admixtures of interest include finely divided mineral admixtures such as cementitious materials; pozzolans; pozzolanic and cementitious materials; and nominally inert materials. Pozzolans include diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618.

Other types of admixture of interest include plasticizers, accelerators, retarders, air-entrainers, foaming agents, water reducers, corrosion inhibitors, and pigments.

As such, admixtures of interest include, but are not limited to: set accelerators, set retarders, air-entraining agents, defoamers, alkali-reactivity reducers, bonding admixtures, dispersants, coloring admixtures, corrosion inhibitors, dampproofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. Admixtures are well-known in the art and any suitable admixture of the above type or any other desired type may be used; see, e.g., U.S. Pat. No. 7,735,274, incorporated herein by reference in its entirety.

In some instances, the settable composition is produced using an amount of a bicarbonate rich product (BRP) admixture, which may be liquid or solid form, e.g., as described in U.S. patent application Ser. No. 14/112,495 published as United States Published Application Publication No. 2014/0234946; the disclosure of which is herein incorporated by reference.

In certain embodiments, settable compositions of the invention include a cement employed with fibers, e.g., where one desires fiber-reinforced concrete. Fibers can be made of zirconia containing materials, steel, carbon, fiberglass, or synthetic materials, e.g., polypropylene, nylon, polyethylene, polyester, rayon, high-strength aramid, (i.e. Kevlar®), or mixtures thereof.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

Following the combination of the components to produce a settable composition (e.g., concrete), the settable composition are in some instances initially flowable compositions, and then set after a given period of time. The setting time may vary, and in certain embodiments ranges from 30 minutes to 48 hours, such as 30 minutes to 24 hours and including from 1 hour to 4 hours.

The strength of the set product may also vary. In certain embodiments, the strength of the set cement may range from 5 Mpa to 70 MPa, such as 10 MPa to 50 MPa and including from 20 MPa to 40 MPa. In certain embodiments, set products produced from cements of the invention are extremely durable. e.g., as determined using the test method described at ASTM C1157.

### Structures

Aspects of the invention further include structures produced from the aggregates and settable compositions of the invention. As such, further embodiments include manmade structures that contain the aggregates of the invention and methods of their manufacture. Thus in some embodiments the invention provides a manmade structure that includes one or more aggregates as described herein. The manmade structure may be any structure in which an aggregate may be used, such as a building, dam, levee, roadway or any other manmade structure that incorporates an aggregate or rock. In some embodiments, the invention provides a manmade structure, e.g., a building, a dam, or a roadway, that includes an aggregate of the invention that contains CO₂ from a fossil fuel source. In some embodiments the invention provides a method of manufacturing a structure, comprising providing an aggregate of the invention that contains CO₂ from a fossil fuel source. Because these structures are produced from aggregates and/or settable compositions of the invention, they will include markers or components that identify them as being produced by a bicarbonate mediated CO₂ sequestration protocol.

### Utility

The subject aggregate compositions and settable compositions that include the same, find use in a variety of different applications, such as above ground stable CO₂ sequestration products, as well as building or construction materials. Specific structures in which the settable compositions of the invention find use include, but are not limited to: pavements, architectural structures, e.g., buildings, foundations, motorways/roads, overpasses, parking structures, brick/block walls and footings for gates, fences and poles. Mortars of the invention find use in binding construction blocks, e.g., bricks, together and filling gaps between construction blocks. Mortars can also be used to fix existing structure, e.g., to replace sections where the original mortar has become compromised or eroded, among other uses.

The following examples are offered by way of illustration and not by way of limitation.

### EXPERIMENTAL

### I. Abstract

The properties of amorphous calcium carbonate (ACC) and its transformations to crystalline polymorphs are frequently studied in aqueous systems and in small quantities. In this study, synthetic calcium carbonate stones are created from bulk ACC and crystalline polymorphs, which were precipitated from gaseous CO₂, at a gradient of end pH. Some of the ACCs hardened into stones which are durable against an abrasion and impact test, while some of the ACCs create fragile, friable stones. When ACCs which transform to durable stones and those which transform into fragile stones were subject to calorimetry, significant differences were observed. These stones, synthesized from gaseous CO₂, can be used as a storage reservoir for utilized CO₂ in construction and other infrastructure applications.

### II. Introduction

The mineralization of CO₂ as solid stone is a permanent sequestration method for CO₂ emissions (Mazzotti et al., 2005). Most carbon on earth is in inorganic and mineral forms, particularly in carbonate rocks that contain a minimum of 40,000 times more carbon than in the atmosphere (Oelkers et al., 2008). Calcium carbonate, a carbonate mineral with the chemical name of limestone, is 44% CO₂ by weight and can be produced by a reaction of CO₂ with calcium hydroxide, Ca(OH)2, also known as the mineral “portlandite” (Huntzinger et al., 2009).

Some scientists propose injecting waste CO₂ underground, where it can mineralize and be permanently stored (Mazzotti et al., 2005). The current study instead proposes utilizing the sequestered CO₂ by mineralizing it into calcium carbonate in a production facility and further processing it into hardened synthetic stones for use in construction. These synthetic calcium carbonate stones are chemically identical to limestone and could be used instead of natural limestone as aggregate in concrete. Concrete is the second most used material on earth after water, at approximately 30 billion tons per year (Monteiro et al., 2017). It is approximately 70% aggregate (sand and gravel-sized stones) by mass. Stones and sand, called “aggregate” in the industry, are also used for purposes such as asphalt; the total aggregate market is approximately 35 billion tons per year (O'Brien 2021). Therefore, if all construction aggregate was replaced with synthetic stone which was 44% w/w mineralized CO₂, concrete and other construction aggregates could be a potential CO₂ storage reservoir for 15 billion tons of CO₂ per year. This upcycling CO₂ of construction materials can potentially store over a third of the 40 billion tons of CO₂ emitted into the atmosphere per year (Canadell et al., 2021).

Marine organisms mineralize strong structures in rapid timescales (Constantz, 1989; Constantz and Meike, 1989; Cartwright et al., 2012; Morse et al., 2007). We were inspired by nature to create biomimetic and geomimetic materials which sequester CO₂ at biological pHs in aqueous chemistry and rapidly biomineralize the CO₂ into strong materials, as do marine calcifying and aragonitic organisms. The learnings can be used both to study biomineralization using the methods described herein and to protect marine systems by capturing CO₂ emissions, thus preventing ocean acidification.

Calcium carbonate exists in three major crystal forms as well as in an amorphous phase. Under Ostwald's rule of stages, calcium carbonate precipitates as its less stable form, amorphous calcium carbonate (ACC), and then transforms to a meta-stable state, vaterite, and then to a stable state, either aragonite or calcite, depending on conditions (Bots et al., 2012).

It has been observed that ACCs formed under different conditions, whether chemical or biological, will transform into different polymorphs when they crystallize (Gebauer et al., 2010; Cartwright et al., 2012). Under synthetic conditions, some of the factors which can influence the crystallization of ACC include the presence of certain cations and anions such as magnesium, strontium, or sulfate, varying pH, and varying supersaturation (Bots et al., 2012; Jimoh et al., 2017; Albéric et al., 2018).

Various forms of ACC can be characterized by either structural methods, by their empirical properties, or by their transformation into the crystalline polymorphs of calcium carbonate (Shen et al., 2006; Albéric et al., 2018). This study examines the empirical properties of ACC via calorimetry and the ability of ACC to lithify or cement together into a durable synthetic stone during crystallization.

Tobler et al. (2016) found a link between the pH of the synthesis solution of calcium carbonate and the crystallization temperature of the resultant ACCs using calorimetry. Elsewhere, ACC transformation has been studied in the context of the transformation of the amorphous to the crystalline phase as a suspension or as a dispersed, finely-grained phase in an aqueous solution (Tobler et al., 2016; Bots et al., 2012; Albéric et al., 2018). These granular phases and their interactions can be simulated (Mergo and Seto, 2020). We build on these findings to study the link between the conditions of synthesis, the properties of ACC, and its transformation. The calcium carbonate is precipitated in bulk and shaped into synthetic stones. Some of the ACCs harden or lithify into durable stones, while others do not harden or lithify and are essentially a shaped powder. This study demonstrates, through defined processing and chemistries, that ACC can be made into consistent, load-bearing materials for sustainable building applications.

### III. Methods and Materials

### A. ACC Production

First, a calcium- and alkaline-rich solution was formed for the reactants to absorb CO₂ gas and form a CaCO₃ precipitate. To form this solution, a 1.5 M NH₄Cl solution was combined in a 1 kg solid: 1 kg liquid ratio with recycled crushed concrete containing portlandite—Ca(OH)2. When the recycled concrete came into contact with the ammonium chloride solution, the following reaction occurred:

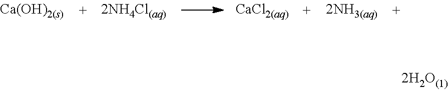

The concrete solids were then separated from the liquid, resulting in an aqueous solution with the calcium and alkalinity necessary to capture CO₂ as mineralized calcium carbonate-CaCO₃. The starting solution's pH was 9.13. Minor concentrations of additional ions were also present due to impurities in the raw material, which was an industrial waste product. The concentrations of the major constituents in the solution used were 298 mM Ca²⁺, 1,506 mM Cl⁻, 60 mM Na⁺, 16 mM K⁺, 227 mM NH₃, and 832 mM NH4⁺.

A measure of 12 L of the pH 9.13 aqueous solution was poured into a 7-gallon (26.5 L) bucket used as a reactor, and 6% (w/w) CO₂ was pumped through a bubbling stone at 5 psi, 13 scfh, and an ambient temperature. As CO₂ was absorbed into the solution, the pH drop was monitored. At target pH values of 8.75, 8.50, 8.25, 8.00, 7.50, and 7.00, the CO₂ flow was paused, the solution was agitated to suspend the precipitate, and a representative aliquot was taken before the CO₂ flow was resumed on the bulk solution. For each aliquot, the sample was aged for 75 min to better represent internal bulk scale methods. At 75 min after sampling, each sample was filtered through a 1.5-μm filter paper and rinsed with five times its mass in tap water to remove the ammonium chloride. The samples at this stage were semisolids containing liquid water and the solid calcium carbonate precipitate, some of which was hydrous ACC containing chemically bound water. To stabilize the ACC, the liquid water needed to be removed such that only the calcium carbonate—including hydrous ACC—remained. Therefore, after rinsing the slurries with water, they were immediately (2 min or less) flash-frozen by submerging in liquid nitrogen. The flash frozen calcium carbonate samples were transferred to a lyophilizer until dry. Amorphous calcium carbonate has hygroscopic properties and can crystallize when it absorbs water from the air (Konrad et al., 2016), so the lyophilized samples were stored in a vacuum desiccator until measured. Konrad et al. (2016) demonstrated that ACC remains amorphous and that hydrous ACC retains its structural-bound water throughout lyophilization and storage in vacuum. Bates et al. (2013) have also shown that bound water can stay stable during and after lyophilization and that information about the bound water can be discerned during XRD analysis. The stability of the ACC and its hydration state through this process, including the aging step, was confirmed using our own ACC synthesis methods before beginning this experiment.

### B. ACC Measurement and Analysis

Each lyophilized sample was measured on a Rigaku MiniFlex XRD system using Cu Kα radiation, from 15° to 90° 2θ, at a step size of 0.03° and a scan rate of 4° per minute.

Quantitative analysis of the XRD data was performed by the direct derivation analysis method on Rigaku's SmartLab Studio II software (Toraya 2018; Toraya 2021).

This method was developed by Toraya at Rigaku Corporation as a novel method of quantifying amorphous phases in XRD. It relies on a total diffraction pattern and the chemical formula of the amorphous phase to calculate the integrated contribution of each phase, including a known formula amorphous phase (Toraya 2016; Toraya 2018; Toraya 2021). See the cited literature for details on this method and its underlying theory.

The structural model of vaterite has been debated, and the nanocrystalline nature of vaterite creates barriers to classical single crystal diffraction studies (Burgess et al., 2014; Christy, 2017; Demichelis et al., 2013; Mugnaioli et al., 2012). The crystal structure most commonly used is hexagonal; however researchers have also proposed monoclinic, orthorhombic, and triclinic structures, as well as multiple point groups within each lattice system (Demichelis et al., 2013; Christy, 2017; Burgess et al., 2014).

The vaterite synthesized by the methods described here exhibits the major vaterite peaks and also diffracts a broad, asymmetric peak at 39° 2θ which is not found in the diffraction pattern of the hexagonal vaterite structure. The broad, asymmetric peak at 39° 2θ found in our diffraction pattern is described well by the triclinic structure model of Demichelis et al. (2013) or, more specifically, as a large number of small peaks between 38° and 41° 2θ. No single structure could describe our diffraction pattern alone, however, and we found that the best fit was a combination of the hexagonal (P63/mmc) and triclinic (C1) structure models, which was the same combination used by Demichelis et al. (2013) and Ševčík et al. (2015). Combinations of vaterite structures within single samples is described in the literature: Kabalah-Amitai et al. observed multiple crystallographic structures within a vaterite pseudo-single crystal, and Demichelis et al. proposed the rotation of carbonate ions within the superstructure at room temperature, resulting in room temperature interchange between symmetries. (Kabalah-Amitai et al., 2013; Demichelis et al., 2012; Demichelis et al., 2013).

Each lyophilized sample was measured for calorimetry on a Hitachi STA 7200 model from 30 C to 575 C at a 10 C/min ramp rate in aluminum pans with nitrogen flush.

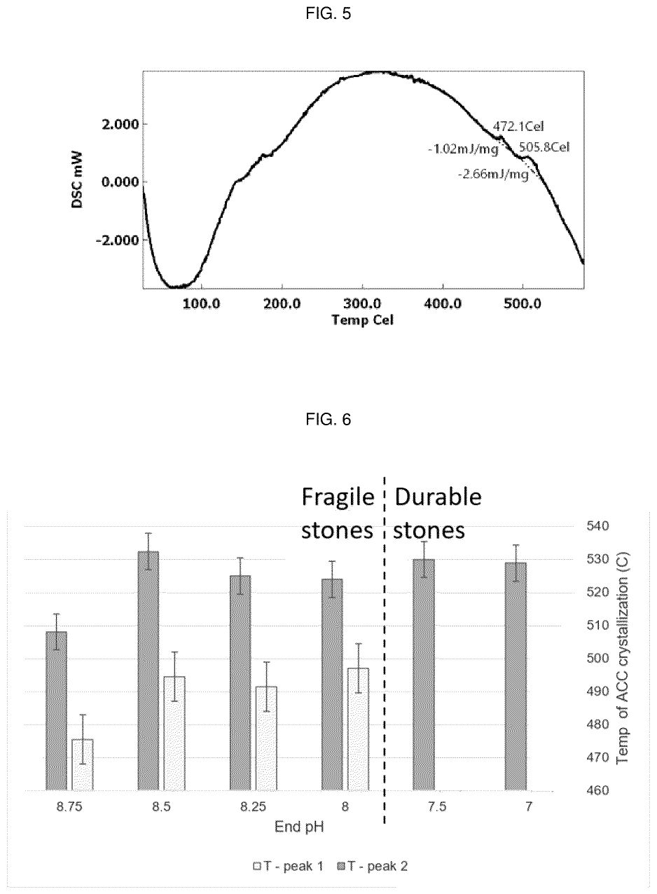

For each sample, the peak temperature of each event was recorded, as well as the area under the peak (FIG. 5A).

Replicates of n=7 were run on one sample to determine the error of measurement of the TGA-x check graphs are determined by this sample.

### C. Bulk Synthetic Stone Preparation

Bulk samples were prepared separately from the preparation of the lyophilized samples and turned into synthetic stones to test the lithification of the precipitates and the resultant mechanical properties of the stones. The same aqueous solution from above was purged with CO₂ using the same conditions. In four separate batches, the end pHs were pH 8.50, 8.00, 7.79, and 7.38. Each of these precipitates was aged to mimic production scale processing, filtered through a 1.5-μm filter paper; then the calcium carbonate filter cake was washed with five times its weight in tap water and filtered to a thick, semisolid consistency. This calcium carbonate and water mixture was shaped into approximately 0.5-2.5 cm rounded stones by tumbling in a rotating drum for approximately 10 min with heated air. These agglomerates cured over 7 days, of which the first 3 days were in a sealed bag.

### D. Bulk Synthetic Stone Measurement (Durability Test)

After the curing step, the stones were tested for durability (resistance to degradation by abrasion and impact) using a “mini Los Angeles (mini LA) abrasion test.” This test is designed as a lab scale version of ASTM (American Society for Testing and Materials) test C131-06, a standard test for the aggregates industry whose title is “Standard Test Method for Resistance to Degradation of Small-Size Coarse Aggregate by Abrasion and Impact in the Los Angeles Machine” (ASTM, 2010). The mini LA abrasion test tumbles 15 g of the calcium carbonate stones with 1,500 g of steel balls (13 balls, three each at 1½″, 1″, and 15/16″ and two at ⅞″) in a rotating cylinder with a shelf. The test tumbles for 1 min 45 s, after which the mass of calcium carbonate stones larger than a #12 (1.7 mm) mesh sieve are measured.

The result here is reported as the percentage surviving the test (g CaCO₃ which was larger than the sieve/g CaCO₃ initial), where more than 60% of the stones' mass surviving the test is a pass result in the ASTM test.

A stone sample which passed the durability (resistance to degradation by abrasion and impact) test is referred to as “durable,” while a stone sample which fails it is “fragile.”

For imaging, each of the synthetic stones was cracked with a hammer, and the fracture surface imaged on SEM.

### IV. Results and Discussion

### A. Overview

The reactants for this CO₂ absorption and calcium carbonate utilization experiment were generated by extracting calcium and alkalinity from waste concrete using an ammonium chloride solution. As gaseous CO₂ was absorbed, the pH dropped, and calcium carbonate precipitated. This precipitate was studied using XRD and calorimetry, and bulk precipitates were also prepared and shaped into synthetic stones.

The end pH had a dramatic correlation with the durability of the stones against abrasion and impact. Precipitate formed from a high-end pH of the reaction created friable, fragile stones, while reactions which proceeded further to a lower end pH created durable stones. The calcium carbonate precipitate which created friable and durable stones was comparable in polymorph composition, as quantified by XRD. However, when the precipitate was studied by calorimetry, differences were observed between the conditions, which resulted in fragile vs. durable stones. The precipitates which resulted in friable, fragile stones had two crystallization events and lower enthalpy release during each of the events. The precipitates which resulted in durable stones each had one crystallization event, which was more exothermic than either of the crystallization events in the fragile material precursors.

### B. Synthetic Stones and Bulk Properties

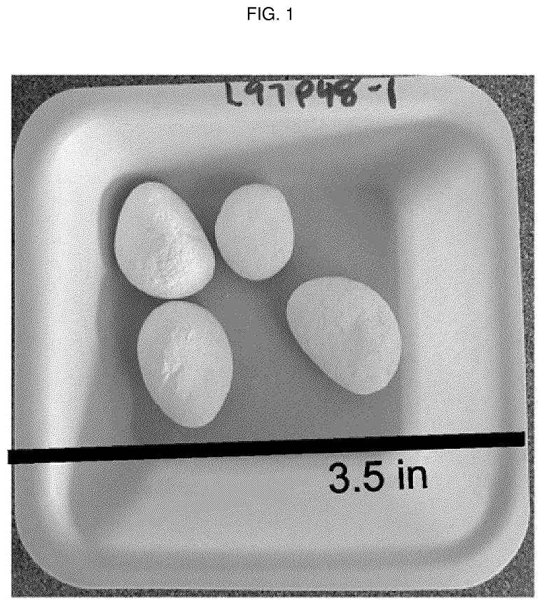

Synthetic stones from all reaction conditions had a rounded, oblong morphology, and the particle size was approximately 0.5-2.5 cm. Synthetic stones from all conditions were a pure white with a matte surface. FIG. 1 shows an image of an aliquot of synthetic stones from the bulk precipitation reaction with end pH 7.38, which is representative of the centimeter-scale morphology of the stones from all reaction conditions.

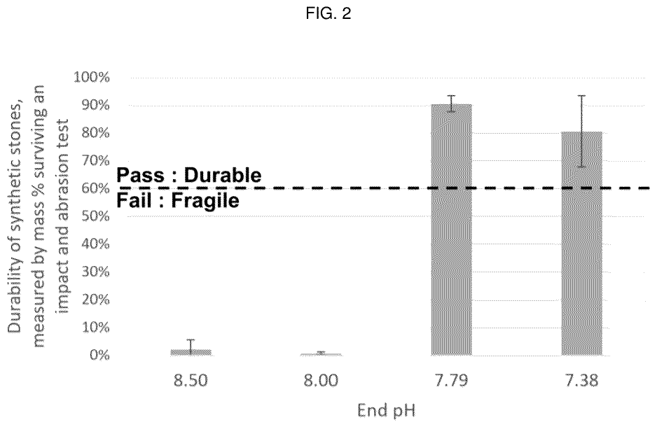

Despite the similar appearances at the macro scale, the synthetic stones had widely varying durabilities. Some synthetic stones made from the bulk calcium carbonate precipitations survived the test for durability against abrasion and impact, while others were almost completely degraded. FIG. 2 shows that, when the precipitation reaction from CO₂ capture was allowed to proceed to lower end pHs of 7.79 and 7.38, the stones were durable, with 80%-90% of their mass surviving the durability against abrasion and impact testing. However, when the precipitation reaction was stopped earlier at higher pHs of 8.50 and 8.00, the stones were highly fragile, defined by having less than 10% of their mass survive in the durability test.

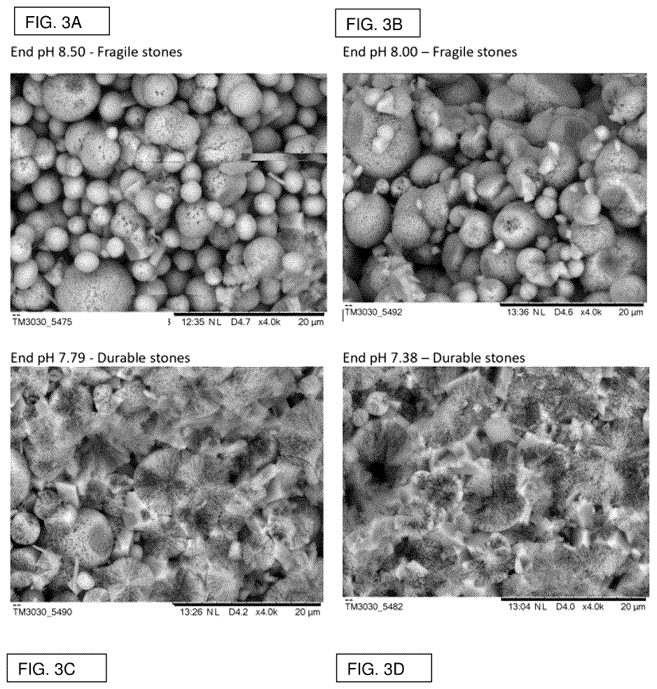

This wide range of durability led to an investigation of the microstructure and links between the microstructure of the cured or lithified stones and the observed durability properties. The structure-property relationship is apparent by observing the SEM images in FIG. 3 of the fracture surfaces of the final synthetic stone products. The friable, fragile products form a packed calcium carbonate powder. As can be seen in FIGS. 3A, B, the first two samples are a packed powder of approximately 2-10 μm particles, with no interconnected structure between the precipitate particles. When a force is applied, the crack propagates between the particles, the calcium carbonate spheres become disconnected, and the product breaks down to a fine powder. In contrast, the durable products show a lithified, interconnected structure. The fracture propagates through the calcium carbonate spheres instead of between them. Therefore, the bonds between calcium carbonate particles are stronger than those within them because fractures propagate through the weakest points in a material. The durable sample in FIG. 3D has a microstructure that appears as an inverse of the fragile and friable samples 3A and 3B. Since calcium carbonate transforms by dissolution-reprecipitation, the spaces between the spheres, which were previously the weak point of the structure, are now filled in with calcium carbonate, cementing into an interconnected continuous phase in the material, resulting in the integrity and cohesion of the durable samples.

In order to be used as construction materials, the stones must pass the ASTM C131-06 test—modified here to be a lab scale test we call the “durability against abrasion and impact test”. Therefore, the stones that were synthesized with low-end pH reactions may be used in concrete, replacing mined virgin rocks such as limestone and providing a profitable market for captured CO₂.

### C. Properties of Calcium Carbonate Precipitate: XRD and Calorimetry

The calcium carbonate precipitates from different reaction end pHs formed synthetic stones with widely varying properties and structures. In correlating precipitate to final synthetic stone properties, one hypothesis is that precipitate that forms fragile synthetic stone is different in polymorphic composition than precipitate that forms durable synthetic stone. For example, it could be that a higher ACC content in a precipitate leads to durable stones, and lower or no ACC content leads to fragile stones. To examine this, powder XRD was taken of each lyophilized sample.

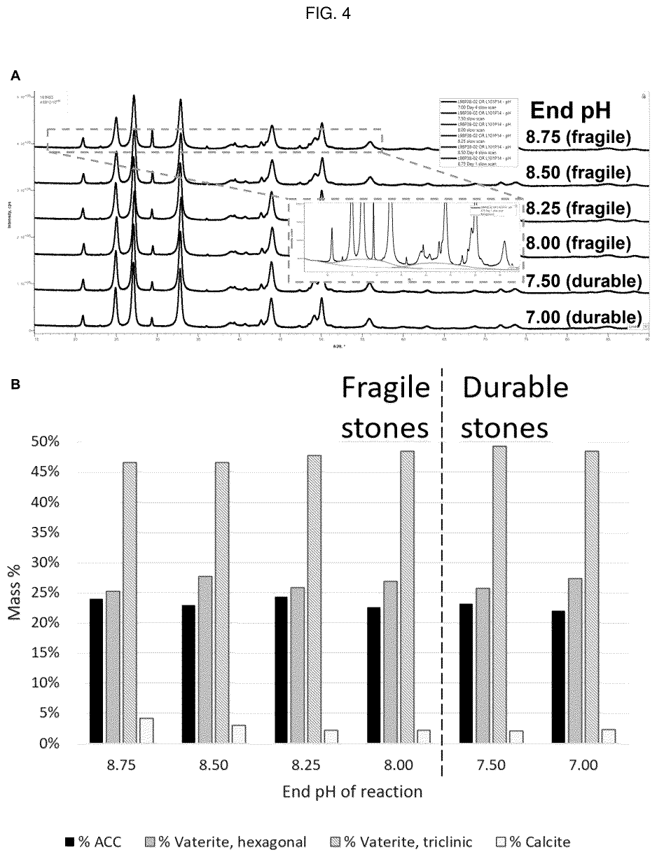

The amounts of ACC, vaterite, and calcite stayed almost constant throughout the pH gradient (FIG. 4). The XRD traces were quantified by the Direct Derivation quantitative analysis method, as discussed in the Methods Section II.B. All differences are quantified to less than 3% (w/w absolute basis).

There was no apparent trend in ACC mass percentage throughout the pH range of the reaction. The ACC content was between 22.0% and 24.3% w/w for all samples. Because the quantity of ACC did not change significantly, the presumption is that one ACC type (lower temperature of crystallization) transformed into the other (higher temperature of crystallization). There were also no apparent trends in other polymorphs, except for calcite, which decreased from 4% to 2% over the first three samples (all of which result in fragile synthetic stones). When comparing the XRD results of the pH ranges that turn to fragile vs. durable synthetic stones, no significant difference was observed. Therefore, it can be concluded that the quantity of ACC or other polymorphs is not correlated with the calcium carbonate's ability to lithify to durable synthetic stone.

The next hypothesis examined was whether the ACC contained in the precipitates that lithify to durable synthetic stones is different from the ACC contained in the precipitates that form fragile stones. To assess the properties of these ACC materials, thermal calorimetry was utilized to determine the exothermic character of the chemical transition from ACC to crystalline materials.

At the threshold between the fragile/failing and durable/passing range of the resultant stones, multiple changes were seen in the calorimetry of the ACCs.

The temperature of each exothermic peak was taken for each sample, as well as the area under the peak (FIG. 5). FIG. 6 shows that the crystallization temperatures were replicable enough to find statistically significant differences between the two major peaks (see Methods and Materials section). The data are shown with error bars from replicate measurements and analysis of the same sample.

The first significant change was in the number of crystallization events, or number of ACC types (FIG. 6). Below pH 8.00, the range in which the precipitate transforms to durable stone, there was only one crystallization event instead of the two found at higher pHs, where the precipitate results in fragile stones. Samples with one type of ACC correlated with durable products, while slurries with two types of ACC correlated with fragile products. For both ACC types, there was also a significant increase in crystallization temperature between pH 8.75 to 8.50; however, this did not correspond to any observed difference in the resultant stones.

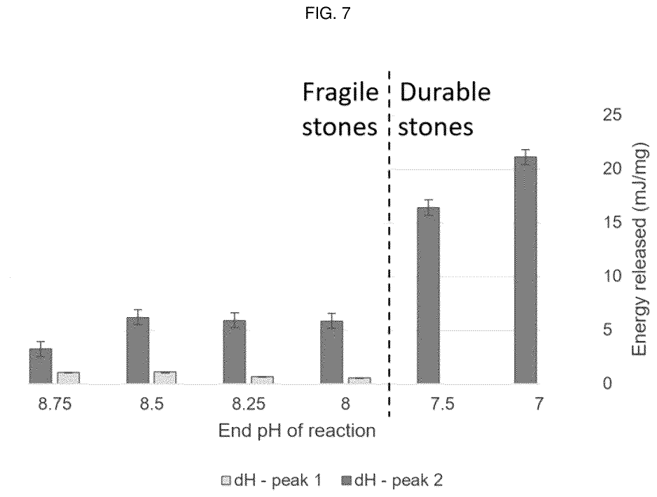

ΔH also correlated strongly with the resultant stone's durability (FIG. 7). Crystallization became significantly more exothermic at the threshold of ACC that transformed to durable products. There are multiple possible causes for this increase in released energy during crystallization. Our hypotheses include the higher transition temperature ACC transforming to calcite instead of vaterite, or the ACC type being anhydrous, releasing less water. Another possible cause is that there was more of this type of ACC (that the energy released per mol was the same but the mass of this ACC phase was higher). The cause of the increase in exothermic nature is outside the scope of the current study. Future work should examine the cause of the difference in exothermic energy release, including characterization of the resultant crystalline phase(s). Future work could also investigate the effect of the lower crystallization temperature ACC on the transformation, such as a stabilizing effect that prevents dissolution-reprecipitation.

### D. Conclusion

The present work utilizes techniques in ACC characterization and applies them in CO₂ capture, building materials, and structure-property relationships. The techniques and learnings may also be applied to biomineralization, where ACC's transformations to hardened materials are frequently studied. The calorimetry results of ACC are linked to its ability to lithify and form products. The end pH of the reaction can be selected to alter the CO₂ capture process to create the desired material properties from the same composition of calcium carbonate. Applying this fundamental research on ACC to creating synthetic stone could have a meaningful impact on climate change by allowing CO₂ to be utilized in building materials. Using the built environment as a reservoir for storing captured CO₂ can provide a commercial path to profitable and scalable CO₂ capture. In addition, biomineralogy research is interested in the crystallization of ACC into strong materials in shellfish. These mineralization processes in the marine environment have a pH near the threshold in the present study. Applying the results of the present study, especially the finding of an effect of pH on the durability of the materials, could be a fruitful path of research for biomineralization research.

### V. References

Albéric, M., Bertinetti, L., Zou, Z., Fratzl, P., Habraken, W., and Politi, Y. (2018). The crystallization of amorphous calcium carbonate is kinetically governed by ion impurities and water. Adv. Sci. 5 (5), 1701000. doi:10.1002/advs.201701000
ASTM (2010). Standard test method for resistance to degradation of small-size Coarse aggregate by abrasion and impact in the Los Angeles machine. Available at: https://www.astm.org/standards/c131.
Bates, S., Jonaitis, D., and Nail, S. (2013). Sucrose lyophiles: a semi-quantitative study of residual water content by total X-ray diffraction analysis. Eur. J. Pharm. Biopharm. 85 (2), 184-188. doi:10.1016/j.ejpb.2013.05.011
Bots, P., Benning, L. G., Rodriguez-Blanco, J. D., Roncal-Herrero, T., and Shaw, S. (2012). Mechanistic insights into the crystallization of amorphous calcium carbonate (ACC). Cryst. Growth & Des. 12 (7), 3806-3814. doi:10.1021/cg300676b
Burgess, K. M., and Bryce, D. L. (2014). On the crystal structure of the vaterite polymorph of CaCO3: a calcium-43 solid-state NMR and computational assessment. Solid State Nuclear Magnetic Resonance 65, 75-83.
Canadell, J. G., Monteiro, P. M., Costa, M. H., Da Cunha, L. C., Cox, P. M., Eliseev, A. V., et al. (2021). Global carbon and other biogeochemical cycles and feedbacks.
Cartwright, J. H., Checa, A. G., Gale, J. D., Gebauer, D., and Sainz-Díaz, C. I. (2012). Calcium carbonate polyamorphism and its role in biomineralization: how many amorphous calcium carbonates are there? Angew. Chem. Int. Ed. 51 (48), 11960-11970. doi:10.1002/anie.201203125
Christy, A. G. (2017). A review of the structures of vaterite: the impossible, the possible, and the likely. Crystal Growth and Design 17 (6), 3567-3578.
Constantz, B., and Meike, A. (1989). “Calcite centers of calcification in Mussa angulosa (Scleractinia),” in Origin, evolution, and modern aspects of biomineralization in plants and animals (Boston, MA: Springer US), 201-207.
Constantz, B. R. (1989). “Skeletal organization in caribbean Acropora spp.(Lamarck),” in Origin, evolution, and modern aspects of biomineralization in plants and animals (Boston, MA: Springer US), 175-199.
Demichelis, R., Raiteri, P., Gale, J. D., and Dovesi, R. (2012). A new structural model for disorder in vaterite from first-principles calculations. CrystEngComm 14 (1), 44-47. doi:10.1039/c1ce05976a
Demichelis, R., Raiteri, P., Gale, J. D., and Dovesi, R. (2013). The multiple structures of vaterite. Cryst. growth & Des. 13 (6), 2247-2251. doi:10.1021/cg4002972
Gebauer, D., Gunawidjaja, P. N., Ko, J. P., Bacsik, Z., Aziz, B., Liu, L., et al. (2010). Proto-calcite and proto-vaterite in amorphous calcium carbonates. Angew. Chem. Int. Ed. 49 (47), 8889-8891. doi:10.1002/anie.201003220
Huntzinger, D. N., Gierke, J. S., Kawatra, S. K., Eisele, T. C., and Sutter, L. L. (2009). Carbon dioxide sequestration in cement kiln dust through mineral carbonation. Environ. Sci. Technol. 43 (6), 1986-1992. doi:10.1021/es802910z
Jimoh, O. A., Ariffin, K. S., Hussin, H. B., and Temitope, A. E. (2017). Synthesis of precipitated calcium carbonate: a review. Carbonates Evaporites 33 (2), 331-346. doi:10.1007/s13146-017-0341-x
Kabalah-Amitai, L., Mayzel, B., Kauffmann, Y., Fitch, A. N., Bloch, L., Gilbert, P. U., and Pokroy, B. (2013). Vaterite crystals contain two interspersed crystal structures. Science 340 (6131), 454-457.
Konrad, F., Gallien, F., Gerard, D. E., and Dietzel, M. (2016). Transformation of amorphous calcium carbonate in air. Cryst. growth & Des. 16 (11), 6310-6317. doi:10.1021/acs.cgd.6b00906
Mazzotti, M., Abanades, J. C., Allam, R., Lackner, K. S., Meunier, F., Rubin, E., et al. (2005). “Mineral carbonation and industrial uses of carbon dioxide,” in IPCC special report on carbon dioxide capture and storage (Cambridge: Cambridge University Press), 330. section 7.2.8.1.
Mergo, J., and Seto, J. (2020). On simulating the formation of structured, crystalline systems via non-classical pathways, Front. Mater 7. 75. doi:10.3389/fmats.2020.00075
Monteiro, P. J., Miller, S. A., and Horvath, A. (2017). Towards sustainable concrete. Nat. Mater. 16 (7), 698-699. doi:10.1038/nmat4930
Morse, J. W., Arvidson, R. S., and Lüttge, A. (2007). Calcium carbonate formation and dissolution. Chem. Rev. 107 (2), 342-381. doi:10.1021/cr050358j
Mugnaioli, E., Andrusenko, I., Schüler, A., Loges, N., Dinnebier, R. E., Panthöfer, M., et al. (2012). Ab initio structure determination of vaterite by automated electron diffraction. Angewandte Chemie International Edition 51 (28), 7041-7045.
O'Brien, J. (2021). Growing global aggregates sustainably. Aggregates Business. Available at: https://www.aggbusiness.com/feature/growing-global-aggregates-sustainably (Accessed Dec. 22, 2023).
Oelkers, E. H., Gislason, S. R., and Matter, J. (2008). Mineral carbonation of CO2. Elements 4 (5), 333-337. doi:10.2113/gselements.4.5.333
Ševčík, R., Pérez-Estébanez, M., Viani, A., Šašek, P., and Mácová, P. (2015). Characterization of vaterite synthesized at various temperatures and stirring velocities without use of additives. Powder Technol. 284, 265-271. doi:10.1016/j.powtec.2015.06.064
Shen, Q., Wei, H., Zhou, Y., Huang, Y., Yang, H., Wang, D., et al. (2006). Properties of amorphous calcium carbonate and the template action of vaterite spheres. J. Phys. Chem. B 110 (7), 2994-3000. doi:10.1021/jp055063o
Tobler, D. J., Rodriguez Blanco, J. D., Sorensen, H. O., Stipp, S. L., and Dideriksen, K. (2016). Effect of pH on amorphous calcium carbonate structure and transformation. Cryst. Growth & Des. 16 (8), 4500-4508. doi:10.1021/acs.cgd.6b00630
Toraya, H. (2016). A new method for quantitative phase analysis using X-ray powder diffraction: direct derivation of weight fractions from observed integrated intensities and chemical compositions of individual phases. J. Appl. Crystallogr. 49 (5), 1508-1516. doi:10.1107/s1600576716010451
Toraya, H. (2018). Direct derivation (DD) of weight fractions of individual crystalline phases from observed intensities and chemical composition data: incorporation of the DD method into the whole-powder-pattern fitting procedure. J. Appl. Crystallogr. 51 (2), 446-455. doi:10.1107/s1600576718001474
Toraya, H. (2021). Review of the direct derivation method: quantitative phase analysis with observed intensities and chemical composition data. Powder Diffr. 36 (3), 159-168. doi:10.1017/s0885715621000373

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A method of producing a durable synthetic aggregate, the method comprising:
obtaining a carbonate slurry from a precipitation reaction mixture having a pH of less than 8; and
subjecting the carbonate slurry to rotational action to produce a durable synthetic aggregate.

2. The method according to claim 1, wherein the carbonate slurry is obtained from a precipitation reaction mixture having a pH ranging from 7 to 7.9.

3. The method according to claim 1, wherein the precipitation reaction mixture is prepared using a CO₂ sequestering process.

4. The method according to claim 3, wherein the CO₂ sequestering process comprises:
a) contacting an aqueous capture liquid with a gaseous source of CO₂ under conditions sufficient to produce an aqueous carbonate; and then combining a cation source and the aqueous carbonate under conditions sufficient to produce a CO₂ sequestering carbonate precipitate; or
b) contacting an aqueous ammonia capture liquid that includes a cation source with the gaseous source of CO₂ under conditions sufficient to produce the CO₂ sequestering carbonate.

5. The method according to claim 4, wherein the aqueous capture liquid comprises an aqueous capture ammonia and optionally an additive.

6. The method according to claim 1, wherein the carbonate slurry is a slurry of metal carbonate particles.

7. The method according to claim 6, wherein the metal carbonate particles are calcium carbonate particles.

8. The method according to claim 7, wherein the metal carbonate particles are calcium magnesium carbonate particles.

9. The method according to claim 1, wherein the carbonate particles comprise sequestered CO₂.

10. The method according to claim 1, wherein the carbonate slurry comprises 40 to 60% solids.

11. The method according to claim 1, wherein the slurry has a viscosity ranging from 2 to 300,000 centipoise.

12. The method according to claim 1, wherein the method comprises washing the precipitate.

13. The method according to claim 1, wherein the carbonate slurry is subjected to the rotational action in combination with an aggregate substrate and the carbonate aggregate product comprises carbonate coated aggregate.

14. A method of producing a durable synthetic aggregate, the method comprising:
obtaining a carbonate slurry from a precipitation reaction mixture produced under precipitation conditions that favor a single amorphous calcium phosphate crystallization event; and
subjecting the carbonate slurry to rotational action to produce a durable synthetic aggregate.

15. The method according to claim 14, wherein the precipitation conditions comprise precipitation at a pH of less than 8.

16. The method according to claim 15, wherein the precipitation conditions comprise precipitation at a pH ranging from 7 to 7.9.

17. The method according to claim 14, wherein the precipitation reaction mixture is prepared using a CO₂ sequestering process.

18. The method according to claim 17, wherein the CO₂ sequestering process comprises:
a) contacting an aqueous capture liquid with a gaseous source of CO₂ under conditions sufficient to produce an aqueous carbonate; and then combining a cation source and the aqueous carbonate under conditions sufficient to produce a CO₂ sequestering carbonate precipitate; or
b) contacting an aqueous ammonia capture liquid that includes a cation source with the gaseous source of CO₂ under conditions sufficient to produce the CO₂ sequestering carbonate.

19. The method according to claim 18, wherein the aqueous capture liquid comprises an aqueous capture ammonia and optionally an additive.

20-40. (canceled)

41. A method of producing a synthetic aggregate, the method comprising:
obtaining a carbonate slurry from a precipitation reaction mixture having predetermined conditions selected to produce a durable or friable aggregate; and
subjecting the carbonate slurry to rotational action to produce a durable synthetic aggregate.

42-59. (canceled)
